(19) United States
(12) Patent Application Publication
(10) Pub. No.: US 2025/0003739 A1
(43) Pub. Date: Jan. 2, 2025

(54) EYE SAFETY FOR PROJECTORS

(71) Applicant: TRINAMIX GMBH, Ludwigshafen Am Rhein (DE)

(72) Inventors: Benjamin REIN, Weinheim (DE); Nils BERNER, Ludwigshafen (DE)

(21) Appl. No.: 18/697,749

(22) PCT Filed: Nov. 3, 2022
(86) PCT No.: PCT/EP2022/080657

§ 371 Date: Apr. 2, 2024

(30) Foreign Application Priority Data
Nov. 4, 2021 (EP) 21206520.5

(51) Int. Cl. G01B 11/25; G01S 7/484; G01S 17/46; G01S 17/89; G06V 10/141; G06V 10/60

(52) U.S. Cl. CPC G01B 11/2513; G01S 7/484; G01S 17/46; G01S 17/89; G06V 10/141; G06V 10/60

(57) ABSTRACT

Disclosed herein is a detector for determining a position of at least one object. The detector includes:
at least one projector for illuminating the object with at least one illumination pattern;
at least one camera, where the camera includes at least one sensor element having a matrix of optical sensors, the optical sensors each having a light-sensitive area;
at least one control unit configured for controlling emission of each of the pulsed light emitters; and
at least one evaluation device configured for determining the position of the object by evaluating the reflection image.

### FIELD OF THE INVENTION

The invention relates to a detector for determining a position of at least one object, a mobile device and a method for determining a position of at least one object. The invention further relates to various uses of the detector. The devices, methods and uses according to the present invention specifically may be employed for example in various areas of daily life, gaming, traffic technology, production technology, security technology, photography such as digital photography or video photography for arts, documentation or technical purposes, medical technology or in the sciences. Further, the invention specifically may be used for scanning one or more objects and/or for scanning a scenery, such as for generating a depth profile of an object or of a scenery, e.g. in the field of architecture, metrology, archaeology, arts, medicine, engineering or manufacturing. However, other applications are also possible.

### PRIOR ART

Several different techniques are known for 3D measurements. 3D measurements may be distinguished into techniques using structured light and techniques using unstructured light. In both cases at least one laser source may be used, wherein eye safety is desirable.

For example, laser based range finders using unstructured light are known. CN102866403 A describes an eye safety laser distance measuring equipment and belongs to the technical field of laser distance measuring equipment. The eye safety laser distance measuring equipment comprises a microprocessor, a laser driving and control unit, a laser transmitting unit, an optical splitting system, a telescoping system and a photoelectric detection and signal amplification unit. An inner cavity type Nd:YAG pumping KTP (potassium titanium oxide phosphate) optical parameter oscillating laser is used as a laser light source.

In the technical field of 3D measurements using structured light, the 3D measurements may be based on a measurement setup comprising at least one camera and at least one light projector. The light projector, typically, generates an illumination pattern, e.g. a point pattern, wherein a resolution of the 3D measurement may depend on a density of the point pattern. The light projector may comprise a laser source run in a continuous illumination mode. On the one hand, the power of the laser source has to be sufficient high to allow sufficient contrast of the points of the pattern such that 3D measurements even in the presence of ambient light are possible. On the other hand, eye safety is desirable. Therefore, usually, for 3D measurements, a laser source of laser class 1 is used. With respect to laser classes, reference is made to DIN EN 60825-1, the full disclosure of which is included herein by reference.

For example, CN102681312B B describes an apparatus or arrangements for taking photographs or for projecting or viewing them and apparatus or arrangements employing analogous techniques using waves other than optical waves. A human eye safety protection system of a laser projection system is described. At least a detecting component is arranged at one same side of a laser projector and is used for detecting and obtaining relevant data correspondingly generated when a projection path of an imaging light is obstructed by an object which invades between the projector and a screen, and the data are used as the event influence data; at least a control component is electrically connected with the laser projector; the control component is provided with at least a comparison judgment mechanism and starting standard data for human eye safety protection for carrying out comparison judgment on the event influence data provided by the detecting component and the set starting standard data, wherein when the condition that the event influence data provided by the detecting component is different from the starting standard data or the difference of the two data reaches a certain ratio or degree is judged by the control component, the laser projector is controlled by the control component to weaken or close the power of a laser imaging light, so that the damage to the human eye is avoided.

Despite the described achievements, technical challenges remain for 3D measurements using structured light to improve the known techniques in view of high power of the laser source on the one hand and eye safety on the other hand.

### Problem Addressed by the Invention

It is therefore an object of the present invention to provide devices and methods facing the above-mentioned technical challenges of known devices and methods. Specifically, it is an object of the present invention to provide devices and methods allowing to improve known 3D measurement techniques using structured light in view of high power of the laser source on the one hand and eye safety on the other hand.

### SUMMARY OF THE INVENTION

This problem is solved by the invention with the features of the independent patent claims. Advantageous developments of the invention, which can be realized individually or in combination, are presented in the dependent claims and/or in the following specification and detailed embodiments.

In a first aspect of the present invention a detector for determining a position of at least one object is disclosed.

The term “detector” as used herein is a broad term and is to be given its ordinary and customary meaning to a person of ordinary skill in the art and is not to be limited to a special or customized meaning. The term specifically may refer, without limitation, to an arbitrary sensor device configured for determining and/or detecting and/or sensing the at least one object. The detector may be a stationary device or a mobile device. Further, the detector may be a stand-alone device or may form part of another device, such as a computer, a vehicle or any other device. Further, the detector may be a hand-held device. Other embodiments of the detector are feasible. The detector may be one of attached to or integrated into a mobile device such as a mobile phone or smartphone. The detector may be integrated in a mobile device, e.g. within a housing of the mobile device. Additionally or alternatively, the detector, or at least one component of the detector, may be attached to the mobile device such as by using a connector such as a USB or phone-connector such as the headphone jack.

The term “object” as used herein is a broad term and is to be given its ordinary and customary meaning to a person of ordinary skill in the art and is not to be limited to a special or customized meaning. The term specifically may refer, without limitation, to an arbitrary object, in particular a surface or region, which is configured to reflect at least partially at least one light beam impinging on the object. The light beam may originate from a projector illuminating the object, wherein the light beam is reflected or scattered by the object. For example, the object may be a human, in particular a face.

The term “position” as used herein is a broad term and is to be given its ordinary and customary meaning to a person of ordinary skill in the art and is not to be limited to a special or customized meaning. The term specifically may refer, without limitation, to at least one item of information regarding a location of the object and/or at least one part of the object in space. Thus, the at least one item of information may imply at least one distance between at least one point of the object and the at least one detector. The distance may be a longitudinal coordinate or may contribute to determining a longitudinal coordinate of the point of the object. Additionally or alternatively, one or more other items of information regarding the location of the object and/or at least one part of the object may be determined. As an example, additionally, at least one transversal coordinate of the object and/or at least one part of the object may be determined. Thus, the position of the object may imply at least one longitudinal coordinate of the object and/or at least one part of the object. Additionally or alternatively, the position of the object may imply at least one transversal coordinate of the object and/or at least one part of the object. Moreover, the position may imply information about orientation of the object in space. The term “orientation” as used herein is a broad term and is to be given its ordinary and customary meaning to a person of ordinary skill in the art and is not to be limited to a special or customized meaning. The term specifically may refer, without limitation, to angular position of the object in space. The orientation may be given by three spatial angles.

The detector comprises
at least one projector for illuminating the object with at least one illumination pattern, wherein the illumination pattern comprises a plurality of illumination features, wherein the projector comprises at least one array of pulsed light emitters, wherein each of the pulsed light emitters is configured for emitting at least one light beam;
at least one camera, wherein the camera comprises at least one sensor element having a matrix of optical sensors, the optical sensors each having a light-sensitive area, wherein each optical sensor is designed to generate at least one sensor signal in response to an illumination of its respective light-sensitive area by a reflection light beam propagating from the object to the camera, wherein the camera is configured for imaging at least one reflection image comprising a plurality of reflection features;
at least one control unit configured for controlling emission of each of the pulsed light emitters, wherein the controlling of the emission comprises controlling at least one pulse parameter;
at least one evaluation device configured for determining the position of the object by evaluating the reflection image.

The term “projector”, also denoted as light projector, as used herein is a broad term and is to be given its ordinary and customary meaning to a person of ordinary skill in the art and is not to be limited to a special or customized meaning. The term specifically may refer, without limitation, to an optical device configured to project at least one illumination pattern onto the object, specifically onto a surface of the object.

The term “pattern” as used herein is a broad term and is to be given its ordinary and customary meaning to a person of ordinary skill in the art and is not to be limited to a special or customized meaning. The term specifically may refer, without limitation, to an arbitrary known or pre-determined arrangement comprising a plurality of arbitrarily shaped features such as symbols. The pattern may comprise a plurality of features. The pattern may comprise an arrangement of periodic or non-periodic features. The term “at least one illumination pattern” as used herein is a broad term and is to be given its ordinary and customary meaning to a person of ordinary skill in the art and is not to be limited to a special or customized meaning. The term specifically may refer, without limitation, to at least one arbitrary pattern comprising the illumination features adapted to illuminate at least one part of the object.

The term “illumination feature” as used herein is a broad term and is to be given its ordinary and customary meaning to a person of ordinary skill in the art and is not to be limited to a special or customized meaning. The term specifically may refer, without limitation, to at least one at least partially extended feature of the pattern. The illumination pattern comprises a plurality of illumination features. The illumination pattern may comprise at least one pattern selected from the group consisting of: at least one quasi random pattern; at least one Sobol pattern; at least one quasiperiodic pattern; at least one point pattern, in particular a pseudo-random point pattern or a random point pattern; at least one line pattern; at least one stripe pattern; at least one checkerboard pattern; at least one triangular pattern; at least one rectangular pattern; at least one hexagonal pattern or a pattern comprising further convex tilings. The illumination pattern may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. For example, the illumination pattern comprises at least one pattern comprising at least one pre-known feature. For example, the illumination pattern comprises at least one line pattern comprising at least one line. For example, the illumination pattern comprises at least one line pattern comprising at least two lines such as parallel or crossing lines. For example, the projector may be configured for generate and/or to project a cloud of points or non-point-like features. For example, the projector may be configured for generate a cloud of points or nonpoint-like features such that the illumination pattern may comprise a plurality of point features or non-point-like features.

The illumination pattern may comprise at least two areas having different densities of the illumination features. One of the areas may have a lower density of the illumination features than the other one. The term “density” of the illumination features as used herein is a broad term and is to be given its ordinary and customary meaning to a person of ordinary skill in the art and is not to be limited to a special or customized meaning. The term specifically may refer, without limitation, to a number of illumination features per area. The illumination pattern may comprise at least two sub-patterns, wherein one sub-pattern is arranged in the area with the lower density and another sub-pattern is arranged in the area with the higher density. A distance between two features of the respective illumination pattern may depend on a circle of confusion in a reflection image determined by at least one detector. The area with the lower density of the illumination features may have a larger distance between two illumination features than the area with the higher density. The area of the illumination pattern having the higher density may comprise as many features per area as possible, e.g. a densely packed hexagonal pattern may be preferred. Each of the sub-patterns may comprise an arrangement of periodic or non periodic features. For example, each of the areas may comprise a periodic point pattern. Each of the areas may comprise at least one regular and/or constant and/or periodic pattern.

The object may be a human face. The human face may be subdivided into an eye area comprising the human's eyes and other parts of the face, e.g. skin areas. The eye area, as the skilled person knows, requires specific protection from optical radiation. The control unit may be configured for controlling the projector such that the area with the lower density of the illumination features is projected to a predefined area of the object. Specifically, the control unit is configured for controlling the projector such that the area with the lower density is projected to the eye area of the human face. Projecting a lower density sub-pattern to the eye area may allow reducing the amount of optical radiation for the eyes and, thus, eye protection. The higher density sub-pattern may allow high resolution distance measurements in the other parts of the face.

As further used herein, the term “illuminating the object with at least one illumination pattern” may refer to providing the at least one illumination pattern for illuminating the at least one object.

The term “ray” as used herein is a broad term and is to be given its ordinary and customary meaning to a person of ordinary skill in the art and is not to be limited to a special or customized meaning. The term specifically may refer, without limitation, to a line that is perpendicular to wavefronts of light which points in a direction of energy flow. The term “beam” as used herein is a broad term and is to be given its ordinary and customary meaning to a person of ordinary skill in the art and is not to be limited to a special or customized meaning. The term specifically may refer, without limitation, to a collection of rays. In the following, the terms “ray” and “beam” will be used as synonyms. The term “light beam” as used herein is a broad term and is to be given its ordinary and customary meaning to a person of ordinary skill in the art and is not to be limited to a special or customized meaning. The term specifically may refer, without limitation, to an amount of light, specifically an amount of light traveling essentially in the same direction, including the possibility of the light beam having a spreading angle or widening angle. The light beam may have a spatial extension. Specifically, the light beam may have a non-Gaussian beam profile. The beam profile may be selected from the group consisting of a trapezoid beam profile; a triangle beam profile; a conical beam profile. The trapezoid beam profile may have a plateau region and at least one edge region. The light beam specifically may be a Gaussian light beam or a linear combination of Gaussian light beams, as will be outlined in further detail below. Other embodiments are feasible, however.

The light beams generated by the emitters generally may propagate parallel to an optical axis or tilted with respect to the optical axis, e.g. including an angle with the optical axis. The detector may be configured such that the light beam or light beams propagates from the detector towards the object along an optical axis of the detector. For this purpose, the detector may comprise at least one reflective element, preferably at least one prism, for deflecting the light beams onto the optical axis. As an example, the light beams and the optical axis may include an angle of less than 10°, preferably less than 5° or even less than 2°. Other embodiments, however, are feasible. Further, the light beams may be on the optical axis or off the optical axis. As an example, the light beam or light beams may be parallel to the optical axis having a distance of less than 10 mm to the optical axis, preferably less than 5 mm to the optical axis or even less than 1 mm to the optical axis or may even coincide with the optical axis.

The projector comprises the at least one array of emitters. The term “emitter” as used herein is a broad term and is to be given its ordinary and customary meaning to a person of ordinary skill in the art and is not to be limited to a special or customized meaning. The term specifically may refer, without limitation, to at least one arbitrary device configured for providing the at least one light beam for illumination of the object. Each of the emitters may be and/or may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser (VCSEL); at least one non-laser light source such as at least one LED or at least one light bulb.

The array of emitters may be a two-dimensional or one dimensional array. The array may comprise a plurality of emitters arranged in a matrix. The term “matrix” as used herein is a broad term and is to be given its ordinary and customary meaning to a person of ordinary skill in the art and is not to be limited to a special or customized meaning. The term specifically may refer, without limitation, to an arrangement of a plurality of elements in a predetermined geometrical order. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point.

The array of emitters may comprise at least two different array areas. The term “array area” as used herein is a broad term and is to be given its ordinary and customary meaning to a person of ordinary skill in the art and is not to be limited to a special or customized meaning. The term specifically may refer, without limitation, to an arbitrary shaped subsection and/or part of the array. The emitters may be divided into subsections and/or parts of the array. The respective array area may comprise a plurality of emitters of the array. For example, the array may be divided into two areas having different densities of the light emitters. One of the areas may have a lower density of the light emitters than the other one. The lower and higher density areas of emitters may correspond to the lower and higher density areas of the illumination pattern.

For example, the emitters may be an array of VCSELs. The term “vertical-cavity surface-emitting laser” as used herein is a broad term and is to be given its ordinary and customary meaning to a person of ordinary skill in the art and is not to be limited to a special or customized meaning. The term specifically may refer, without limitation, to a semiconductor laser diode configured for laser beam emission perpendicular with respect to a top surface. Examples for VCSELs can be found e.g. in en.wikipedia.org/wiki/Vertical-cavity_surface-emitting_laser. VCSELs are generally known to the skilled person such as from WO 2017/222618 A. Each of the VCSELs is configured for generating at least one light beam. The VCSELs may be arranged on a common substrate or on different substrates. The array may comprise up to 2500 VCSELs. For example, the array may comprise 38×25 VCSELs, such as a high power array with 3.5 W. For example, the array may comprise 10×27 VCSELs with 2.5 W. For example, the array may comprise 96 VCSELs with 0.9 W. A size of the array, e.g. of 2500 elements, may be up to 2 mm×2 mm.

The light beam emitted by the respective emitter may have a wavelength of 300 to 1100 nm, preferably 500 to 1100 nm. For example, the light beam may have a wavelength of 940 nm. For example, light in the infrared spectral range may be used, such as in the range of 780 nm to 3.0 μm. Specifically, the light in the part of the near infrared region where silicon photodiodes are applicable specifically in the range of 700 nm to 1100 nm may be used. The emitters may be configured for generating the at least one illumination pattern in the infrared region, in particular in the near infrared region. Using light in the near infrared region may allows that light is not or only weakly detected by human eyes and is still detectable by silicon sensors, in particular standard silicon sensors. For example, the emitters may be an array of VCSELs. The VCSELs may be configured for emitting light beams at a wavelength range from 800 to 1000 nm. For example, the VCSELs may be configured for emitting light beams at 808 nm, 850 nm, 940 nm, or 980 nm. Preferably the VCSELs emit light at 940 nm, since terrestrial sun radiation has a local minimum in irradiance at this wavelength, e.g. as described in CIE 085-1989, “Solar spectral Irradiance”.

The light emitters are pulsed light emitters. The illumination pattern may be pulsed. Specifically, the complete illumination pattern may be pulsed. The term “pulsed” as used herein is a broad term and is to be given its ordinary and customary meaning to a person of ordinary skill in the art and is not to be limited to a special or customized meaning. The term specifically may refer, without limitation, to non-continuous emission, in particular having an emission duration of less than 0.25 s. The light emitters may be configured for emitting repetitive pulses, in particular a pulse train. The pulsed light emitters may emit the light beams at spaced points in time. Between the emission of the light beams the pulsed light emitters may not emit light. The control unit is configured for controlling emission of each of the pulsed light emitters. The controlling of the emission comprises controlling at least one pulse parameter, in particular a plurality of pulse parameters. The pulse parameter may comprise at least one parameter selected from the group consisting of: pulse width, pulse shape, beginning of pulse, end of pulse, pulse period, repetition rate, energy per pulse, radiant flux, radiant exposure, radiant intensity. The term “pulse width” as used herein is a broad term and is to be given its ordinary and customary meaning to a person of ordinary skill in the art and is not to be limited to a special or customized meaning. The term specifically may refer, without limitation, to a time between a beginning and end of a pulse, specifically a full width half maximum (FWHM) of a pulse shape. The term “pulse period” as used herein is a broad term and is to be given its ordinary and customary meaning to a person of ordinary skill in the art and is not to be limited to a special or customized meaning. The term specifically may refer, without limitation, to a time between a beginning of one pulse and a beginning of a next pulse. The term “repetition rate” as used herein is a broad term and is to be given its ordinary and customary meaning to a person of ordinary skill in the art and is not to be limited to a special or customized meaning. The term specifically may refer, without limitation, to a frequency with which pulses are emitted. Specifically, the repetition rate is equal to the reciprocal of a period. The term “energy per pulse” (E), also denoted as irradiance, as used herein is a broad term and is to be given its ordinary and customary meaning to a person of ordinary skill in the art and is not to be limited to a special or customized meaning. The term specifically may refer, without limitation, to radiant flux divided by the area irradiated. The term “radiant flux” (P), also denoted as radiant power, as used herein is a broad term and is to be given its ordinary and customary meaning to a person of ordinary skill in the art and is not to be limited to a special or customized meaning. The term specifically may refer, without limitation, to a time rate of transfer of radiant energy. The term “radiant exposure” (H), as used herein is a broad term and is to be given its ordinary and customary meaning to a person of ordinary skill in the art and is not to be limited to a special or customized meaning. The term specifically may refer, without limitation, to radiant energy divided by the area irradiated. The term “radiant intensity” (I), as used herein is a broad term and is to be given its ordinary and customary meaning to a person of ordinary skill in the art and is not to be limited to a special or customized meaning. The term specifically may refer, without limitation, to radiant power of a source transmitted in a particular direction. The respective pulse parameter may be controlled such that at least one pre-defined limit for the respective pule parameter for laser class 1 is fulfilled, e.g. as defined in DIN EN 60825-1.

The control unit may be configured for controlling exposure times of the light emitters such that the light emitters emit their light beams with high intensity of emission and long break times. The exposure times and break times may be defined by the pulse width and the repetition rate. The exposure times may have microsecond timescales. For example, the exposure times are from 1 ms to 2 ms. Using such short exposure times may prevent the eye from focusing such that further eye protection can be reached. The exposure times may be set such that limits for exposure times for laser class 1 are fulfilled, e.g. as defined in DIN EN 60825-1. The proposed short exposure times may allow running the light emitters with high power and at the same time fulfilling the requirements for laser class 1, e.g. as defined in DIN EN 60825-1. The possibility of running the light emitters with high power may allow ensuring sufficient contrast for the reflection image for determining the position of the object, therefrom.

For example, each of the light emitters may comprises at least one shutter and/or the light emitters may comprise a common shutter. The control unit may be configured for controlling exposure times by controlling the shutter. The term “shutter”, as used herein is a broad term and is to be given its ordinary and customary meaning to a person of ordinary skill in the art and is not to be limited to a special or customized meaning. The term specifically may refer, without limitation, to an optical element configured for blocking light to pass. The shutter may be configured for temporally blocking light from the light emitters and temporally allowing light from the light emitters to pass. The blocking may comprise complete blocking of light and/or at least partially blocking light such that light from the respective emitters. For example, the blocking may comprise blocking of more than 90% of incoming intensity, preferably of more than 95% of incoming intensity. The control unit may be configured for controlling the shutter e.g. by rotating and/or mechanically opening and closing apertures. Additionally or alternatively, the control unit may be configured for driving the array of emitters such that the array is non-continuously emitting light. The control unit may be configured for, in particular periodically, turning off and on the light emitters of the array. The controlling may be performed by hardware such as by at least one electrical circuit and/or by software. The control unit may be configured for synchronizing the imaging of the camera and the emission of the pulsed light emitters. Specifically, the emission of the pulsed light emitters, in particular the repetition rate, may be synchronized to an imaging frame rate of the camera. For example, the emission of the light emitters may be synchronized to a 60 Hz—imaging frame rate of the camera. For example, the camera may be active, i.e. in a mode for capturing images and/or detecting light, during the emission. For example, the synchronization of the camera and the light emitters may be realized by the camera emitting a VSYNC signal, also denoted as camera VSYNC, to the control unit and a strobe signal to the projector, wherein the control unit issues in response to the camera VSYNC a trigger signal to the projector for activating the light emitters. In case the trigger signal and the strobe signal are received by the projector, the light emitter may start with the emission(s). However, other embodiments for synchronizing camera and projector are possible.

The term “control unit”, as used herein is a broad term and is to be given its ordinary and customary meaning to a person of ordinary skill in the art and is not to be limited to a special or customized meaning. The term specifically may refer, without limitation, to an arbitrary device configured for controlling the projector by using at least one processor and/or at least one application-specific integrated circuit. Thus, as an example, the control unit may comprise at least one data processing device having a software code stored thereon comprising a number of computer commands. The control unit may provide one or more hardware elements for performing one or more of the named operations and/or may provide one or more processors with software running thereon for performing one or more of the named operations. Thus, as an example, the control unit may comprise one or more programmable devices such as one or more computers, application-specific integrated circuits (ASICs), Digital Signal Processors (DSPs), or Field Programmable Gate Arrays (FPGAs) which are configured to perform the above-mentioned controlling. Additionally or alternatively, however, the control unit may also fully or partially be embodied by hardware.

The projector may comprise the at least one transfer device configured for generating the illumination features from the light beams impinging on the transfer device. The term “transfer device”, also denoted as “transfer system” as used herein is a broad term and is to be given its ordinary and customary meaning to a person of ordinary skill in the art and is not to be limited to a special or customized meaning. The term specifically may refer, without limitation, to one or more optical elements which are adapted to modify the light beam, such as by modifying one or more of a beam parameter of the light beam, a width of the light beam or a direction of the light beam. The transfer device may comprise at least one imaging optical device. The transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system; at least one holographic optical element; at least one meta optical element. Specifically, the transfer device comprises at least one refractive optical lens stack. Thus, the transfer device may comprise a multi-lens system having refractive properties.

In addition to the projector, the detector may comprise further illumination sources. For example, the detector comprises at least one flood light source configured for illuminating a scene comprising the object. The illumination from the flood light source may have a predefined and/or predetermined light direction. The camera may be configured for imaging at least one pixelated flood image of the scene. The term “flood light source”, as used herein is a broad term and is to be given its ordinary and customary meaning to a person of ordinary skill in the art and is not to be limited to a special or customized meaning. The term specifically may refer, without limitation, to at least one arbitrary device adapted to provide the at least one illumination light beam for illumination of the object. The flood light source may be configured for scene illumination. As used herein, the term “scene illumination” may refer to diffuse and/or uniform illumination of the scene. As used herein, the term “scene” may refer to at least one arbitrary object or spatial region. The scene may comprise the at least one object and a surrounding environment. The flood light source may be adapted to directly or indirectly illuminating the object, wherein the illumination is reflected or scattered by surfaces of the object and, thereby, is at least partially directed towards the sensor element. The flood light source may be adapted to illuminate the object, for example, by directing a light beam towards the object, which reflects the light beam. The flood light source may comprise at least one light-emitting-diode (LED). However, other embodiments are feasible. For example, the flood light source may comprise at least one VCSEL and at least one diffusor as light source. The flood light source may comprise a single light source or a plurality of light sources. The flood light source may emit light in the same wavelength as the projector or may emit light in at least one further wavelength range.

The projector and/or the flood light source may constitute a coordinate system, wherein a longitudinal coordinate is a coordinate along the optical axis. The coordinate system may be a polar coordinate system in which the optical axis forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate z. Any direction perpendicular to the z-axis may be considered a transversal direction, and the polar coordinate and/or the polar angle may be considered a transversal coordinate. As used herein, the term “depth information” may relate to the longitudinal coordinate and/or information from which the longitudinal coordinate can be derived.

The term “camera”, as used herein is a broad term and is to be given its ordinary and customary meaning to a person of ordinary skill in the art and is not to be limited to a special or customized meaning. The term specifically may refer, without limitation, to a device having at least one imaging element configured for recording or capturing spatially resolved one-dimensional, two-dimensional or even three-dimensional optical data or information. As an example, the camera may comprise at least one camera chip, such as at least one CCD chip and/or at least one CMOS chip configured for recording images. As used herein, without limitation, the term “image” specifically may relate to data recorded by using a camera, such as a plurality of electronic readings from the imaging device, such as the pixels of the camera chip. For example, the camera is or comprises at least one near infrared camera.

The camera comprises the at least one sensor element having a matrix of optical sensors. As used herein, the term “sensor element” may generally refer to a device or a combination of a plurality of devices configured for sensing at least one parameter. In the present case, the parameter specifically may be an optical parameter, and the sensor element specifically may be an optical sensor element. The sensor element may be formed as a unitary, single device or as a combination of several devices. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point. For example, the matrix may be a single row of pixels. Other arrangements are feasible.

As used herein, an “optical sensor” generally may refer to a light-sensitive device for detecting a light beam, such as for detecting an illumination and/or a light spot generated by at least one light beam. As further used herein, a “light-sensitive area” generally refers to an area of the optical sensor which may be illuminated externally, by the at least one light beam, in response to which illumination the at least one sensor signal is generated. The light-sensitive area may specifically be located on a surface of the respective optical sensor. Other embodiments, however, are feasible. The optical sensors of the matrix specifically may be equal in one or more of size, sensitivity and other optical, electrical and mechanical properties. The light-sensitive areas of all optical sensors of the matrix specifically may be located in a common plane, the common plane preferably facing the object, such that a light beam propagating from the object to the detector may generate a light spot on the common plane.

As used herein, the term “the optical sensors each having at least one light sensitive area” refers to configurations with a plurality of single optical sensors each having one light sensitive area and to configurations with one combined optical sensor having a plurality of light sensitive areas. Thus, the term “optical sensor” furthermore refers to a light-sensitive device configured to generate one output signal, whereas, herein, a light-sensitive device configured to generate two or more output signals, for example at least one CCD and/or CMOS device, is referred to as two or more optical sensors. Each optical sensor may be embodied such that precisely one light-sensitive area is present in the respective optical sensor, such as by providing precisely one light-sensitive area which may be illuminated, in response to which illumination precisely one uniform sensor signal is created for the whole optical sensor. Thus, each optical sensor may be a single area optical sensor. The use of the single area optical sensors, however, renders the setup of the detector specifically simple and efficient. Thus, as an example, commercially available photo-sensors, such as commercially available silicon photodiodes, each having precisely one sensitive area, may be used in the setup. Other embodiments, however, are feasible. Thus, as an example, an optical device comprising two, three, four or more than four light-sensitive areas may be used which is regarded as two, three, four or more than four optical sensors in the context of the present invention. As outlined above, the sensor element comprises a matrix of optical sensors. Thus, as an example, the optical sensors may be part of or constitute a pixelated optical device. As an example, the optical sensors may be part of or constitute at least one CCD and/or CMOS device having a matrix of pixels, each pixel forming a light-sensitive area.

The optical sensors specifically may be or may comprise photodetectors, preferably inorganic photodetectors, more preferably inorganic semiconductor photodetectors, most preferably silicon photodetectors. Specifically, the optical sensors may be sensitive in the infrared spectral range. All of the optical sensors of the matrix or at least a group of the optical sensors of the matrix specifically may be identical. Groups of identical optical sensors of the matrix specifically may be provided for different spectral ranges, or all optical sensors may be identical in terms of spectral sensitivity. Further, the optical sensors may be identical in size and/or with regard to their electronic or optoelectronic properties.

Specifically, the optical sensors may be or may comprise inorganic photodiodes which are sensitive in the infrared spectral range, preferably in the range of 780 nm to 3.0 micrometers. Specifically, the optical sensors may be sensitive in the part of the near infrared region where silicon photodiodes are applicable specifically in the range of 700 nm to 1000 nm. Infrared optical sensors which may be used for optical sensors may be commercially available infrared optical sensors, such as infrared optical sensors commercially available under the brand name Hertzstueck™ from trinamiX GmbH, D-67056 Ludwigshafen am Rhein, Germany. Thus, as an example, the optical sensors may comprise at least one optical sensor of an intrinsic photovoltaic type, more preferably at least one semiconductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensors may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensors may comprise at least one bolometer, preferably a bolometer selected from the group consisting of a VO bolometer and an amorphous Si bolometer.

The matrix may be composed of independent optical sensors. Thus, a matrix may be composed of inorganic photodiodes. Alternatively, however, a commercially available matrix may be used, such as one or more of a CCD detector, such as a CCD detector chip, and/or a CMOS detector, such as a CMOS detector chip.

Thus, generally, the optical sensors of the detector may form a sensor array or may be part of a sensor array, such as the above-mentioned matrix. Thus, as an example, the detector may comprise an array of optical sensors, such as a rectangular array, having m rows and n columns, with m, n, independently, being positive integers. Preferably, more than one column and more than one row is given, i.e. n>1, m>1. Thus, as an example, n may be 2 to 16 or higher and m may be 2 to 16 or higher. Preferably, the ratio of the number of rows and the number of columns is close to 1. As an example, n and m may be selected such that 0.3<m/n 3, such as by choosing m/n=1:1, 4:3, 16:9 or similar. As an example, the array may be a square array, having an equal number of rows and columns, such as by choosing m=2, n=2 or m=3, n=3 or the like.

The matrix specifically may be a rectangular matrix having at least one row, preferably a plurality of rows, and a plurality of columns. As an example, the rows and columns may be oriented essentially perpendicular, wherein, with respect to the term “essentially perpendicular”, reference may be made to the definition given above. Thus, as an example, tolerances of less than 20°, specifically less than 100 or even less than 5°, may be acceptable. In order to provide a wide range of view, the matrix specifically may have at least 10 rows, preferably at least 50 rows, more preferably at least 100 rows. Similarly, the matrix may have at least 10 columns, preferably at least 50 columns, more preferably at least 100 columns. The matrix may comprise at least 50 optical sensors, preferably at least 100 optical sensors, more preferably at least 500 optical sensors. The matrix may comprise a number of pixels in a multi-mega pixel range. Other embodiments, however, are feasible. Thus, in setups in which an axial rotational symmetry is to be expected, circular arrangements or concentric arrangements of the optical sensors of the matrix, which may also be referred to as pixels, may be preferred.

Preferably, the sensor element may be oriented essentially perpendicular to an optical axis of the detector. Again, with respect to the term “essentially perpendicular”, reference may be made to the definition and the tolerances given above. The optical axis may be a straight optical axis or may be bent or even split, such as by using one or more deflection elements and/or by using one or more beam splitters, wherein the essentially perpendicular orientation, in the latter cases, may refer to the local optical axis in the respective branch or beam path of the optical setup.

The reflection light beam may propagate from the object towards the camera. The reflection light beam may originate from the object. The projector may illuminate the object with the at least one illumination pattern and the light is remitted, reflected and/or scattered by the object and, thereby, is at least partially directed as “reflection light beams” towards the camera.

The reflection light beam specifically may fully illuminate the sensor element such that the sensor element is fully located within the light beam with a width of the light beam being larger than the matrix. Contrarily, preferably, the reflection light beam specifically may create a light spot on the entire matrix which is smaller than the matrix, such that the light spot is fully located within the matrix. This situation may easily be adjusted by a person skilled in the art of optics by choosing one or more appropriate lenses or elements having a focusing or defocusing effect on the light beam, such as by using an appropriate transfer device as will be outlined in further detail below.

The light-sensitive areas specifically may be oriented towards the object. As used herein, the term “is oriented towards the object” generally refers to the situation that the respective surfaces of the light-sensitive areas are fully or partially visible from the object. Specifically, at least one interconnecting line between at least one point of the object and at least one point of the respective light-sensitive area may form an angle with a surface element of the light-sensitive area which is different from 0°, such as an angle in the range of 20° to 90°, preferably 80 to 90° such as 90°. Thus, when the object is located on the optical axis or close to the optical axis, the light beam propagating from the object towards the detector may be essentially parallel to the optical axis. As used herein, the term “essentially perpendicular” refers to the condition of a perpendicular orientation, with a tolerance of e.g. ±20° or less, preferably a tolerance of ±10⁰ or less, more preferably a tolerance of ±5° or less. Similarly, the term “essentially parallel” refers to the condition of a parallel orientation, with a tolerance of e.g. ±20° or less, preferably a tolerance of ±10° or less, more preferably a tolerance of ±5° or less.

The optical sensors may be sensitive in one or more of the ultraviolet, the visible or the infrared spectral range. Specifically, the optical sensors may be sensitive in the visible spectral range from 500 nm to 780 nm, most preferably at 650 nm to 750 nm or at 690 nm to 700 nm. Specifically, the optical sensors may be sensitive in the near infrared region. Specifically, the optical sensors may be sensitive in the part of the near infrared region where silicon photodiodes are applicable specifically in the range of 700 nm to 1000 nm. The optical sensors, specifically, may be sensitive in the infrared spectral range, specifically in the range of 780 nm to 3.0 micrometers. For example, the optical sensors each, independently, may be or may comprise at least one element selected from the group consisting of a photodiode, a photocell, a photoconductor, a phototransistor or any combination thereof. For example, the optical sensors may be or may comprise at least one element selected from the group consisting of a CCD sensor element, a CMOS sensor element, a photodiode, a photocell, a photoconductor, a phototransistor or any combination thereof. Any other type of photosensitive element may be used. As will be outlined in further detail below, the photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

As further used herein, a “sensor signal” generally refers to a signal generated by an optical sensor in response to the illumination by the light beam. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be configured for process or preprocess the sensor signal, thereby generating secondary sensor signals, which may also be used as sensor signals, such as preprocessing by filtering or the like.

As used herein, the term “reflection image” may generally refer to an image determined by the optical sensor comprising a plurality of reflection features. As used herein, the term “reflection feature” may generally refer to a feature in an image plane generated by the object in response to illumination with at least one illumination feature. The reflection image may comprise the at least one reflection pattern comprising the reflection features. As used herein, the term “imaging at least one reflection image” refers to one or more of capturing, recording and generating of the reflection image.

Each of the reflection features comprises at least one beam profile. As used herein, the term “beam profile” generally may refer to a spatial distribution, in particular in at least one plane perpendicular to the propagation of the light beam, of an intensity of the light beam. The beam profile may be a transverse intensity profile of the light beam. The beam profile may be a cross section of the light beam. The beam profile may be selected from the group consisting of a trapezoid beam profile; a triangle beam profile; a conical beam profile and a linear combination of Gaussian beam profiles. Other embodiments are feasible, however.

The evaluation device is configured for determining the position of the object by evaluating the reflection image.

The evaluation device may be configured for selecting reflection features of the respective first and second reflection images. As used herein, the term “select at least one reflection feature” may generally refer to one or more of identifying, determining and choosing at least one reflection feature of the reflection image. The evaluation device may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing an object within an image generated by the optical sensors.

The evaluation device may be configured for performing at least one image correction. The image correction may comprise at least one background subtraction. The evaluation device may be adapted to remove influences from background light from the beam profile, for example, by an imaging without further illumination.

The term “evaluation device” generally may refer to an arbitrary device adapted to perform the named operations, preferably by using at least one data processing device and, more preferably, by using at least one processor and/or at least one application-specific integrated circuit. Thus, as an example, the at least one evaluation device may comprise at least one data processing device having a software code stored thereon comprising a number of computer commands. The evaluation device may provide one or more hardware elements for performing one or more of the named operations and/or may provide one or more processors with software running thereon for performing one or more of the named operations. Operations, including evaluating the images. Specifically the determining the beam profile and indication of the surface, may be performed by the at least one evaluation device. Thus, as an example, one or more instructions may be implemented in software and/or hardware. Thus, as an example, the evaluation device may comprise one or more programmable devices such as one or more computers, application-specific integrated circuits (ASICs), Digital Signal Processors (DSPs), or Field Programmable Gate Arrays (FPGAs) which are configured to perform the above-mentioned evaluation. Additionally or alternatively, however, the evaluation device may also fully or partially be embodied by hardware.

The evaluation device may be or may comprise one or more integrated circuits, such as one or more application-specific integrated circuits (ASICs), and/or one or more data processing devices, such as one or more computers, preferably one or more microcomputers and/or microcontrollers, Field Programmable Arrays, or Digital Signal Processors. Additional components may be comprised, such as one or more preprocessing devices and/or data acquisition devices, such as one or more devices for receiving and/or preprocessing of the sensor signals, such as one or more AD-converters and/or one or more filters. Further, the evaluation device may comprise one or more measurement devices, such as one or more measurement devices for measuring electrical currents and/or electrical voltages. Further, the evaluation device may comprise one or more data storage devices. Further, the evaluation device may comprise one or more interfaces, such as one or more wireless interfaces and/or one or more wire-bound interfaces.

The evaluation device can be connected to or may comprise at least one further data processing device that may be used for one or more of displaying, visualizing, analyzing, distributing, communicating or further processing of information, such as information obtained by the optical sensor and/or by the evaluation device. The data processing device, as an example, may be connected or incorporate at least one of a display, a projector, a monitor, an LCD, a TFT, a loudspeaker, a multichannel sound system, an LED pattern, or a further visualization device. It may further be connected or incorporate at least one of a communication device or communication interface, a connector or a port, capable of sending encrypted or unencrypted information using one or more of email, text messages, telephone, Bluetooth, Wi-Fi, infrared or internet interfaces, ports or connections. It may further be connected to or incorporate at least one of a processor, a graphics processor, a CPU, an Open Multimedia Applications Platform (OMAP™), an integrated circuit, a system on a chip such as products from the Apple A series or the Samsung S3C2 series, a microcontroller or microprocessor, one or more memory blocks such as ROM, RAM, EEPROM, or flash memory, timing sources such as oscillators or phaselocked loops, counter-timers, real-time timers, or power-on reset generators, voltage regulators, power management circuits, or DMA controllers. Individual units may further be connected by buses such as AMBA buses or be integrated in an Internet of Things or Industry 4.0 type network.

The evaluation device and/or the data processing device may be connected by or have further external interfaces or ports such as one or more of serial or parallel interfaces or ports, USB, Centronics Port, FireWire, HDMI, Ethernet, Bluetooth, RFID, Wi-Fi, USART, or SPI, or analogue interfaces or ports such as one or more of ADCs or DACs, or standardized interfaces or ports to further devices such as a 2D-camera device using an RGB-interface such as CameraLink. The evaluation device and/or the data processing device may further be connected by one or more of interprocessor interfaces or ports, FPGA-FPGA-interfaces, or serial or parallel interfaces ports. The evaluation device and the data processing device may further be connected to one or more of an optical disc drive, a CD-RW drive, a DVD+RW drive, a flash drive, a memory card, a disk drive, a hard disk drive, a solid state disk or a solid state hard disk.

The evaluation device and/or the data processing device may be connected by or have one or more further external connectors such as one or more of phone connectors, RCA connectors, VGA connectors, hermaphrodite connectors, USB connectors, HDMI connectors, 8P8C connectors, BCN connectors, IEC 60320 C14 connectors, optical fiber connectors, D-subminiature connectors, RF connectors, coaxial connectors, SCART connectors, XLR connectors, and/or may incorporate at least one suitable socket for one or more of these connectors.

The detector further may comprise at least one further transfer device. The detector may further comprise one or more additional elements such as one or more additional optical elements. The detector may comprise at least one optical element selected from the group consisting of: transfer device, such as at least one lens and/or at least one lens system, at least one diffractive optical element. The further transfer device, also denoted as “transfer system”, may comprise one or more optical elements which are adapted to modify the light beam, such as by modifying one or more of a beam parameter of the light beam, a width of the light beam or a direction of the light beam. The further transfer device may be adapted to guide the light beam onto the optical sensor. The further transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system. The further transfer device may have a focal length. As used herein, the term “focal length” of the further transfer device refers to a distance over which incident collimated rays which may impinge the transfer device are brought into a “focus” which may also be denoted as “focal point”. Thus, the focal length constitutes a measure of an ability of the further transfer device to converge an impinging light beam. Thus, the further transfer device may comprise one or more imaging elements which can have the effect of a converging lens. By way of example, the further transfer device can have one or more lenses, in particular one or more refractive lenses, and/or one or more convex mirrors. In this example, the focal length may be defined as a distance from the center of the thin refractive lens to the principal focal points of the thin lens. For a converging thin refractive lens, such as a convex or biconvex thin lens, the focal length may be considered as being positive and may provide the distance at which a beam of collimated light impinging the thin lens as the transfer device may be focused into a single spot. Additionally, the further transfer device can comprise at least one wavelength-selective element, for example at least one optical filter. Additionally, the further transfer device can be designed to impress a predefined beam profile on the electromagnetic radiation, for example, at the location of the sensor region and in particular the sensor area. The abovementioned optional embodiments of the further transfer device can, in principle, be realized individually or in any desired combination.

The further transfer device may have an optical axis. As used herein, the term “optical axis of the further transfer device” generally refers to an axis of mirror symmetry or rotational symmetry of the lens or lens system. The further transfer system, as an example, may comprise at least one beam path, with the elements of the transfer system in the beam path being located in a rotationally symmetrical fashion with respect to the optical axis. Still, one or more optical elements located within the beam path may also be off-centered or tilted with respect to the optical axis. In this case, however, the optical axis may be defined sequentially, such as by interconnecting the centers of the optical elements in the beam path, e.g. by interconnecting the centers of the lenses, wherein, in this context, the optical sensors are not counted as optical elements. The optical axis generally may denote the beam path. Therein, the detector may have a single beam path along which a light beam may travel from the object to the optical sensors, or may have a plurality of beam paths. As an example, a single beam path may be given or the beam path may be split into two or more partial beam paths. In the latter case, each partial beam path may have its own optical axis. In case of a plurality of optical sensors, the optical sensors may be located in one and the same beam path or partial beam path. Alternatively, however, the optical sensors may also be located in different partial beam paths.

The further transfer device may constitute a coordinate system, wherein a longitudinal coordinate is a coordinate along the optical axis and wherein d is a spatial offset from the optical axis. The coordinate system may be a polar coordinate system in which the optical axis of the transfer device forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate. Any direction perpendicular to the z-axis may be considered a transversal direction, and the polar coordinate and/or the polar angle may be considered a transversal coordinate.

The evaluation device may be configured for determining the x- and y-coordinates of the reflection features from their xy-coordinates in the pixelated reflection image. The evaluation device may be configured for determining the position of the object, in particular its longitudinal coordinate, by one or more of a beam profile analysis technique, at least one triangulation method.

For example, the evaluation device is configured for determining a longitudinal coordinate, also denoted as z_{DPR}, for each of the reflection features by using a beam profile analysis technique comprising analysis of a beam profile of the reflection feature. The beam profile analysis will be described in the following.

As used herein, the term “analysis of the beam profile” may generally refer to evaluating of the beam profile and may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device may be configured for symmetrizing and/or for normalizing and/or for filtering the beam profile, in particular to remove noise or asymmetries from recording under larger angles, recording edges or the like. The evaluation device may filter the beam profile by removing high spatial frequencies such as by spatial frequency analysis and/or median filtering or the like. Summarization may be performed by center of intensity of the light spot and averaging all intensities at the same distance to the center. The evaluation device may be configured for normalizing the beam profile to a maximum intensity, in particular to account for intensity differences due to the recorded distance. The evaluation device may be configured for removing influences from background light from the beam profile, for example, by an imaging without illumination.

The reflection feature may cover or may extend over at least one pixel of the reflection image. For example, the reflection feature may cover or may extend over plurality of pixels. The evaluation device may be configured for determining and/or for selecting all pixels connected to and/or belonging to the reflection feature, e.g. a light spot. The evaluation device may be configured for determining the center of intensity by

$${R}_{coi} = \frac{1}{{I}_{t o t a l}} {\sum }_{j} {r}_{p i x e l} ( j ) I ( j )$$

wherein R_{coi} is the position of center of intensity, rₚᵢₓₑₗ (j) is the pixel position and I(j) the intensity of pixel j connected to and/or belonging to the reflection feature and Iₜₒₜₐₗ being the total intensity.

The evaluation device may be configured for determining the longitudinal coordinate for each of the reflection features by using a depth-from-photon-ratio technique, also denoted as beam profile analysis. With respect to depth-from-photon-ratio (DPR) technique reference is made to WO 2018/091649 A1, WO 2018/091638 A1, WO 2018/091640 A1 and C. Lennartz, F. Schick, S. Metz, “Whitepaper—Beam Profile Analysis for 3D imaging and material detection” Apr. 28, 2021, Ludwigshafen, Germany, the full content of which is included by reference.

The evaluation device may be configured for determining the beam profile of each of the reflection features. As used herein, the term “determining the beam profile” refers to identifying at least one reflection feature provided by the optical sensor and/or selecting at least one reflection feature provided by the optical sensor and evaluating at least one intensity distribution of the reflection feature. As an example, a region of the matrix may be used and evaluated for determining the intensity distribution, such as a three-dimensional intensity distribution or a two-dimensional intensity distribution, such as along an axis or line through the matrix. As an example, a center of illumination by the light beam may be determined, such as by determining the at least one pixel having the highest illumination, and a cross-sectional axis may be chosen through the center of illumination. The intensity distribution may an intensity distribution as a function of a coordinate along this cross-sectional axis through the center of illumination. Other evaluation algorithms are feasible.

The analysis of the beam profile of one of the reflection features may comprise determining at least one first area and at least one second area of the beam profile. The first area of the beam profile may be an area A1 and the second area of the beam profile may be an area A2. The evaluation device may be configured for integrating the first area and the second area. The evaluation device may be configured to derive a combined signal Q, also denoted as quotient Q, by one or more of dividing the integrated first area and the integrated second area, dividing multiples of the integrated first area and the integrated second area, dividing linear combinations of the integrated first area and the integrated second area.

The evaluation device may configured for determining at least two areas of the beam profile and/or to segment the beam profile in at least two segments comprising different areas of the beam profile, wherein overlapping of the areas may be possible as long as the areas are not congruent. For example, the evaluation device may be configured for determining a plurality of areas such as two, three, four, five, or up to ten areas. The evaluation device may be configured for segmenting the light spot into at least two areas of the beam profile and/or to segment the beam profile in at least two segments comprising different areas of the beam profile. The evaluation device may be configured for determining for at least two of the areas an integral of the beam profile over the respective area. The evaluation device may be configured for comparing at least two of the determined integrals. Specifically, the evaluation device may be configured for determining at least one first area and at least one second area of the beam profile. As used herein, the term “area of the beam profile” generally refers to an arbitrary region of the beam profile at the position of the optical sensor used for determining the combined signal. The first area of the beam profile and the second area of the beam profile may be one or both of adjacent or overlapping regions. The first area of the beam profile and the second area of the beam profile may be not congruent in area. For example, the evaluation device may be configured for dividing a sensor region of the sensor element into at least two sub-regions, wherein the evaluation device may be configured for dividing the sensor region of the sensor element into at least one left part and at least one right part and/or at least one upper part and at least one lower part and/or at least one inner and at least one outer part. Additionally or alternatively, the detector may comprise at least two optical sensors, wherein the light-sensitive areas of a first optical sensor and of a second optical sensor may be arranged such that the first optical sensor is adapted to determine the first area of the beam profile of the reflection feature and that the second optical sensor is adapted to determine the second area of the beam profile of the reflection feature. The evaluation device may be adapted to integrate the first area and the second area.

The first area of the beam profile may comprise essentially edge information of the beam profile and the second area of the beam profile comprises essentially center information of the beam profile, and/or the first area of the beam profile may comprise essentially information about a left part of the beam profile and the second area of the beam profile comprises essentially information about a right part of the beam profile. The beam profile may have a center, i.e. a maximum value of the beam profile and/or a center point of a plateau of the beam profile and/or a geometrical center of the light spot, and falling edges extending from the center. The second region may comprise inner regions of the cross section and the first region may comprise outer regions of the cross section. As used herein, the term “essentially center information” generally refers to a low proportion of edge information, i.e. proportion of the intensity distribution corresponding to edges, compared to a proportion of the center information, i.e. proportion of the intensity distribution corresponding to the center. Preferably, the center information has a proportion of edge information of less than 10%, more preferably of less than 5%, most preferably the center information comprises no edge content. As used herein, the term “essentially edge information” generally refers to a low proportion of center information compared to a proportion of the edge information. The edge information may comprise information of the whole beam profile, in particular from center and edge regions. The edge information may have a proportion of center information of less than 10%, preferably of less than 5%, more preferably the edge information comprises no center content. At least one area of the beam profile may be determined and/or selected as second area of the beam profile if it is close or around the center and comprises essentially center information. At least one area of the beam profile may be determined and/or selected as first area of the beam profile if it comprises at least parts of the falling edges of the cross section. For example, the whole area of the cross section may be determined as first region.

Other selections of the first area A1 and second area A2 may be feasible. For example, the first area may comprise essentially outer regions of the beam profile and the second area may comprise essentially inner regions of the beam profile. For example, in case of a two-dimensional beam profile, the beam profile may be divided in a left part and a right part, wherein the first area may comprise essentially areas of the left part of the beam profile and the second area may comprise essentially areas of the right part of the beam profile.

The edge information may comprise information relating to a number of photons in the first area of the beam profile and the center information may comprise information relating to a number of photons in the second area of the beam profile. The evaluation device may be configured for determining an area integral of the beam profile. The evaluation device may be configured for determining the edge information by integrating and/or summing of the first area. The evaluation device may be configured for determining the center information by integrating and/or summing of the second area. For example, the beam profile may be a trapezoid beam profile and the evaluation device may be configured for determining an integral of the trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

In one embodiment, A1 may correspond to a full or complete area of a feature point on the optical sensor. A2 may be a central area of the feature point on the optical sensor. The central area may be a constant value. The central area may be smaller compared to the full area of the feature point. For example, in case of a circular feature point, the central area may have a radius from 0.1 to 0.9 of a full radius of the feature point, preferably from 0.4 to 0.6 of the full radius. In one embodiment, the illumination pattern may comprise at least point pattern. A1 may correspond to an area with a full radius of a point of the point pattern on the optical sensors. A2 may be a central area of the point in the point pattern on the optical sensors. The central area may be a constant value. The central area may have a radius compared to the full radius. For example, the central area may have a radius from 0.1 to 0.9 of the full radius, preferably from 0.4 to 0.6 of the full radius.

The evaluation device may be configured to derive the quotient Q by one or more of dividing the first area and the second area, dividing multiples of the first area and the second area, dividing linear combinations of the first area and the second area. The evaluation device may be configured for deriving the quotient Q by

$$Q = \frac{\int {\int }_{A 1} E ( x , y ) dxdy}{\int {\int }_{A 2} E ( x , y ) dxdy}$$

wherein x and y are transversal coordinates, A1 and A2 are the first and second area of the beam profile, respectively, and E(x,y) denotes the beam profile.

Additionally or alternatively, the evaluation device may be adapted to determine one or both of center information or edge information from at least one slice or cut of the light spot. This may be realized, for example, by replacing the area integrals in the quotient Q by a line integral along the slice or cut. For improved accuracy, several slices or cuts through the light spot may be used and averaged. In case of an elliptical spot profile, averaging over several slices or cuts may result in improved distance information.

For example, in case of the optical sensor having a matrix of pixels, the evaluation device may be configured for evaluating the beam profile, by
determining the pixel having the highest sensor signal and forming at least one center signal;
evaluating sensor signals of the matrix and forming at least one sum signal;
determining the quotient Q by combining the center signal and the sum signal; and
determining at least one longitudinal coordinate z of the object by evaluating the quotient Q.

The sensor signal may be a signal generated by the optical sensor and/or at least one pixel of the optical sensor in response to illumination. Specifically, the sensor signal may be or may comprise at least one electrical signal, such as at least one analogue electrical signal and/or at least one digital electrical signal. More specifically, the sensor signal may be or may comprise at least one voltage signal and/or at least one current signal. More specifically, the sensor signal may comprise at least one photocurrent. Further, either raw sensor signals may be used, or the detector, the optical sensor or any other element may be adapted to process or preprocess the sensor signal, thereby generating secondary sensor signals, which may also be used as sensor signals, such as preprocessing by filtering or the like. The term “center signal” generally refers to the at least one sensor signal comprising essentially center information of the beam profile. As used herein, the term “highest sensor signal” refers to one or both of a local maximum or a maximum in a region of interest. For example, the center signal may be the signal of the pixel having the highest sensor signal out of the plurality of sensor signals generated by the pixels of the entire matrix or of a region of interest within the matrix, wherein the region of interest may be predetermined or determinable within an image generated by the pixels of the matrix. The center signal may arise from a single pixel or from a group of optical sensors, wherein, in the latter case, as an example, the sensor signals of the group of pixels may be added up, integrated or averaged, in order to determine the center signal. The group of pixels from which the center signal arises may be a group of neighboring pixels, such as pixels having less than a predetermined distance from the actual pixel having the highest sensor signal, or may be a group of pixels generating sensor signals being within a predetermined range from the highest sensor signal. The group of pixels from which the center signal arises may be chosen as large as possible in order to allow maximum dynamic range. The evaluation device may be adapted to determine the center signal by integration of the plurality of sensor signals, for example the plurality of pixels around the pixel having the highest sensor signal. For example, the beam profile may be a trapezoid beam profile and the evaluation device may be adapted to determine an integral of the trapezoid, in particular of a plateau of the trapezoid.

As outlined above, the center signal generally may be a single sensor signal, such as a sensor signal from the pixel in the center of the light spot, or may be a combination of a plurality of sensor signals, such as a combination of sensor signals arising from pixels in the center of the light spot, or a secondary sensor signal derived by processing a sensor signal derived by one or more of the aforementioned possibilities. The determination of the center signal may be performed electronically, since a comparison of sensor signals is fairly simply implemented by conventional electronics, or may be performed fully or partially by software. Specifically, the center signal may be selected from the group consisting of: the highest sensor signal; an average of a group of sensor signals being within a predetermined range of tolerance from the highest sensor signal; an average of sensor signals from a group of pixels containing the pixel having the highest sensor signal and a predetermined group of neighboring pixels; a sum of sensor signals from a group of pixels containing the pixel having the highest sensor signal and a predetermined group of neighboring pixels; a sum of a group of sensor signals being within a predetermined range of tolerance from the highest sensor signal; an average of a group of sensor signals being above a predetermined threshold; a sum of a group of sensor signals being above a predetermined threshold; an integral of sensor signals from a group of optical sensors containing the optical sensor having the highest sensor signal and a predetermined group of neighboring pixels; an integral of a group of sensor signals being within a predetermined range of tolerance from the highest sensor signal; an integral of a group of sensor signals being above a predetermined threshold.

Similarly, the term “sum signal” generally refers to a signal comprising essentially edge information of the beam profile. For example, the sum signal may be derived by adding up the sensor signals, integrating over the sensor signals or averaging over the sensor signals of the entire matrix or of a region of interest within the matrix, wherein the region of interest may be predetermined or determinable within an image generated by the optical sensors of the matrix. When adding up, integrating over or averaging over the sensor signals, the actual optical sensors from which the sensor signal is generated may be left out of the adding, integration or averaging or, alternatively, may be included into the adding, integration or averaging. The evaluation device may be adapted to determine the sum signal by integrating signals of the entire matrix, or of the region of interest within the matrix. For example, the beam profile may be a trapezoid beam profile and the evaluation device may be adapted to determine an integral of the entire trapezoid. Further, when trapezoid beam profiles may be assumed, the determination of edge and center signals may be replaced by equivalent evaluations making use of properties of the trapezoid beam profile such as determination of the slope and position of the edges and of the height of the central plateau and deriving edge and center signals by geometric considerations.

Similarly, the center signal and edge signal may also be determined by using segments of the beam profile such as circular segments of the beam profile. For example, the beam profile may be divided into two segments by a secant or a chord that does not pass the center of the beam profile. Thus, one segment will essentially contain edge information, while the other segment will contain essentially center information. For example, to further reduce the amount of edge information in the center signal, the edge signal may further be subtracted from the center signal.

The quotient Q may be a signal which is generated by combining the center signal and the sum signal. Specifically, the determining may include one or more of: forming a quotient of the center signal and the sum signal or vice versa; forming a quotient of a multiple of the center signal and a multiple of the sum signal or vice versa; forming a quotient of a linear combination of the center signal and a linear combination of the sum signal or vice versa. Additionally or alternatively, the quotient Q may comprise an arbitrary signal or signal combination which contains at least one item of information on a comparison between the center signal and the sum signal.

As used herein, the term “longitudinal coordinate of the object” refers to a distance between the optical sensor and the object. The evaluation device may be configured for using the at least one predetermined relationship between the combined signal and the longitudinal coordinate for determining the longitudinal coordinate. The predetermined relationship may be one or more of an empiric relationship, a semi-empiric relationship and an analytically derived relationship. The evaluation device may comprise at least one data storage device for storing the predetermined relationship, such as a lookup list or a lookup table. The evaluation device may be configured for executing at least one algorithm which computes distances for all reflection features with zero order and higher order.

The evaluation device may be configured for assigning said reflection feature to the corresponding emitter. As used herein, the term “assigning said reflection feature to the corresponding emitter of the array” may generally refer to determining, in particular unambiguously, the one emitter of the array having emitted the illumination feature having caused the selected reflection feature. In known 3D sensing devices, such as devices using triangulation or structured light techniques, solving this correspondence problem is complex and time consuming. The evaluation device may be configured for unambiguously matching of reflection features with corresponding emitters by using the longitudinal coordinate z_{DPR}. The longitudinal coordinate determined with the depth-from-photon-ratio technique can be used for solving the correspondence problem. In that way, distance information per reflection feature can be used to find the correspondence of the known array of emitters. As used herein, the term “matching” may refer to identifying and/or determining and/or evaluating the corresponding emitter and the reflection feature. As used herein, the term “corresponding emitter and reflection feature” may refer to the fact that each of the illumination features of the illumination pattern was generate by one of the emitters, projected to the objected and imaged as reflection feature by the camera, wherein the imaged reflection feature is assigned to the illumination feature having generated said reflection feature. As used herein, the term “unambiguously matching” may refer to that only one reflection feature is assigned to one illumination feature, and thus the emitter, and/or that no other reflection features can be assigned to the same matched illumination feature.

The illumination feature, and thus, the emitter, corresponding to the reflection feature may be determined using epipolar geometry. For description of epipolar geometry reference is made, for example, to chapter 2 in X. Jiang, H. Bunke: “Dreidimensionales Computersehen” Springer, Berlin Heidelberg, 1997. Epipolar geometry may assume that an illumination image, i.e. an image of the non-distorted illumination pattern, and the reflection image may be images determined at different spatial positions and/or spatial orientations having a fixed distance. The distance may be a relative distance, also denoted as baseline. The illumination image may be also denoted as reference image. The evaluation device may be adapted to determine an epipolar line in the reference image. The relative position of the reference image and reflection image may be known. For example, the relative position of the reference image and the reflection image may be stored within at least one storage unit of the evaluation device. The evaluation device may be adapted to determine a straight line extending from a selected reflection feature of the reflection image to a real world feature from which it originates. Thus, the straight line may comprise possible object features corresponding to the selected reflection feature. The straight line and the baseline span an epipolar plane. As the reference image is determined at a different relative constellation from the reflection image, the corresponding possible object features may be imaged on a straight line, called epipolar line, in the reference image. The epipolar line may be the intersection of the epipolar plane and the reference image. Thus, a feature of the reference image corresponding to the selected feature of the reflection image lies on the epipolar line.

Depending on the distance to the object having reflected the illumination feature, the reflection feature corresponding to the illumination feature may be displaced within the reflection image. The reference image may comprise at least one displacement region in which the illumination feature corresponding to the selected reflection feature would be imaged. The displacement region may comprise only one illumination feature. The displacement region may also comprise more than one illumination feature. The displacement region may comprise an epipolar line or a section of an epipolar line. The displacement region may comprise more than one epipolar line or more sections of more than one epipolar line. The displacement region may extend along the epipolar line, orthogonal to an epipolar line, or both. The evaluation device may be adapted to determine the illumination feature along the epipolar line. The evaluation device may be adapted to determine the longitudinal coordinate z for the reflection feature and an error interval ±ε from the combined signal Q to determine a displacement region along an epipolar line corresponding to z±ε or orthogonal to an epipolar line. The measurement uncertainty of the distance measurement using the combined signal Q may result in a displacement region in the second image which is non-circular since the measurement uncertainty may be different for different directions. Specifically, the measurement uncertainty along the epipolar line or epipolar lines may be greater than the measurement uncertainty in an orthogonal direction with respect to the epipolar line or lines. The displacement region may comprise an extend in an orthogonal direction with respect to the epipolar line or epipolar lines. The evaluation device may be adapted to match the selected reflection feature with at least one illumination feature within the displacement region. The evaluation device may be adapted to match the selected feature of the reflection image with the illumination feature within the displacement region by using at least one evaluation algorithm considering the determined longitudinal coordinate z_{DPR}. The evaluation algorithm may be a linear scaling algorithm. The evaluation device may be adapted to determine the epipolar line closest to and/or within the displacement region. The evaluation device may be adapted to determine the epipolar line closest to the image position of the reflection feature. The extent of the displacement region along the epipolar line may be larger than the extent of the displacement region orthogonal to the epipolar line. The evaluation device may be adapted to determine an epipolar line before determining a corresponding illumination feature. The evaluation device may determine a displacement region around the image position of each reflection feature. The evaluation device may be adapted to assign an epipolar line to each displacement region of each image position of the reflection features, such as by assigning the epipolar line closest to a displacement region and/or within a displacement region and/or closest to a displacement region along a direction orthogonal to the epipolar line. The evaluation device may be adapted to determine the illumination feature corresponding to the reflection feature by determining the illumination feature closest to the assigned displacement region and/or within the assigned displacement region and/or closest to the assigned displacement region along the assigned epipolar line and/or within the assigned displacement region along the assigned epipolar line.

Additionally or alternatively, the evaluation device may be configured to perform the following steps:
Determining a displacement region for the image position of each reflection feature;
Assigning an epipolar line to the displacement region of each reflection feature such as by assigning the epipolar line closest to a displacement region and/or within a displacement region and/or closest to a displacement region along a direction orthogonal to the epipolar line;
Assigning and/or determining at least one illumination feature to each reflection feature such as by assigning the illumination feature closest to the assigned displacement region and/or within the assigned displacement region and/or closest to the assigned displacement region along the assigned epipolar line and/or within the assigned displacement region along the assigned epipolar line.

Additionally or alternatively, the evaluation device may be adapted to decide between more than one epipolar line and/or illumination feature to be assigned to a reflection feature such as by comparing distances of reflection features and/or epipolar lines within the illumination image and/or by comparing error weighted distances, such as ε-weighted distances of illumination features and/or epipolar lines within the illumination image and assigning the epipolar line and/or illumination feature in shorter distance and/or ε-weighted distance to the illumination feature and/or reflection feature.

The evaluation device may be configured for determining at least one longitudinal coordinate z_{triang} by using at least one triangulation method. The evaluation device may be adapted to determine a displacement of the illumination feature and the reflection feature. The evaluation device may be adapted to determine the displacement of the matched illumination feature and the selected reflection feature. The evaluation device, e.g. at least one data processing device of the evaluation device, may be configured to determine the displacement of the illumination feature and the reflection feature, in particular by comparing the respective image position of the illumination image and the reflection image. As used herein, the term “displacement” may refer to the difference between an image position in the illumination image to an image position in the reflection image. The evaluation device may be adapted to determine the second longitudinal coordinate of the matched feature using a predetermined relationship between the second longitudinal coordinate and the displacement. The evaluation device may be adapted to determine the pre-determined relationship by using triangulation methods.

In a further aspect, a mobile device configured for determining a position of at least one object is disclosed. The mobile device comprises at least one detector according to the present invention such as according to one or more of the embodiments disclosed above or according to one or more of the embodiments disclosed in further detail below. For details, options and definitions, reference may be made to the detector as discussed above.

The mobile device is one or more of a mobile communication device such as a cell phone or smartphone, a tablet computer, a portable computer.

In a further aspect the present invention discloses a method for determining a position of at least one object by using at least one detector according to the present invention such as according to one or more of the embodiments disclosed above or according to one or more of the embodiments disclosed in further detail below.

The method steps may be performed in the given order or may be performed in a different order. Further, one or more additional method steps may be present which are not listed. Further, one, more than one or even all of the method steps may be performed repeatedly. For details, options and definitions, reference may be made to the detector as discussed above.

The method comprises the following steps:
illuminating at least one object with the illumination pattern using the projector;
controlling emission of the light emitters of the projector by using the control unit;
imaging at least one reflection image comprising a plurality of reflection features generated by the object in response to illumination by the illumination features by using the camera;
determining the position of the object by evaluating the reflection image by using the evaluation device.

In a further aspect a computer program including computer-executable instructions for performing the method according to the present invention when the program is executed on a computer or computer network.

In a further aspect of the present invention, use of the detector according to the present invention, such as according to one or more of the embodiments given above or given in further detail below, is proposed, for a purpose of use, selected from the group consisting of: a position measurement in traffic technology; an entertainment application; a security application; a surveillance application; a safety application; a human-machine interface application; a logistics application; a tracking application; an outdoor application; a mobile application; a communication application; a photography application; a machine vision application; a robotics application; a quality control application; a manufacturing application; a gait monitoring application; a human body monitoring application; home care; smart living, automotive application.

With respect to further uses of the detector and devices of the present invention reference is made to WO 2018/091649 A1, WO 2018/091638 A1, WO 2018/091640 A1 and C. Lennartz, F. Schick, S. Metz, “Whitepaper—Beam Profile Analysis for 3D imaging and material detection” Apr. 28, 2021, Ludwigshafen, Germany, the content of which is included by reference.

As used herein, the terms “have”, “comprise” or “include” or any arbitrary grammatical variations thereof are used in a non-exclusive way. Thus, these terms may both refer to a situation in which, besides the feature introduced by these terms, no further features are present in the entity described in this context and to a situation in which one or more further features are present. As an example, the expressions “A has B”, “A comprises B” and “A includes B” may both refer to a situation in which, besides B, no other element is present in A (i.e. a situation in which A solely and exclusively consists of B) and to a situation in which, besides B, one or more further elements are present in entity A, such as element C, elements C and D or even further elements.

Further, it shall be noted that the terms “at least one”, “one or more” or similar expressions indicating that a feature or element may be present once or more than once typically are used only once when introducing the respective feature or element. Herein, in most cases, when referring to the respective feature or element, the expressions “at least one” or “one or more” are not repeated, non-withstanding the fact that the respective feature or element may be present once or more than once.

Further, as used herein, the terms “preferably”, “more preferably”, “particularly”, “more particularly”, “specifically”, “more specifically” or similar terms are used in conjunction with optional features, without restricting alternative possibilities. Thus, features introduced by these terms are optional features and are not intended to restrict the scope of the claims in any way. The invention may, as the skilled person recognizes, be performed by using alternative features. Similarly, features introduced by “in an embodiment of the invention” or similar expressions are intended to be optional features, without any restriction regarding alternative embodiments of the invention, without any restrictions regarding the scope of the invention and without any restriction regarding the possibility of combining the features introduced in such a way with other optional or non-optional features of the invention.

Overall, in the context of the present invention, the following embodiments are regarded as preferred:

Embodiment 1. A detector for determining a position of at least one object, the detector comprising:
at least one projector for illuminating the object with at least one illumination pattern, wherein the illumination pattern comprises a plurality of illumination features, wherein the projector comprises at least one array of pulsed light emitters, wherein each of the pulsed light emitters is configured for emitting at least one light beam;
at least one camera, wherein the camera comprises at least one sensor element having a matrix of optical sensors, the optical sensors each having a light-sensitive area, wherein each optical sensor is designed to generate at least one sensor signal in response to an illumination of its respective light-sensitive area by a reflection light beam propagating from the object to the camera, wherein the camera is configured for imaging at least one reflection image comprising a plurality of reflection features;
at least one control unit configured for controlling emission of each of the pulsed light emitters, wherein the controlling of the emission comprises controlling at least one pulse parameter;
at least one evaluation device configured for determining the position of the object by evaluating the reflection image.

Embodiment 2. The detector according to the preceding embodiment, wherein the illumination pattern comprises at least two areas having different densities of the illumination features, wherein one of the areas has a lower density of the illumination features than the other one.

Embodiment 3. The detector according to the preceding embodiment, wherein the control unit is configured for controlling the projector such that the area with the lower density of the illumination features is projected to a predefined area of the object.

Embodiment 4. The detector according to the preceding embodiment, wherein the object is a human face, wherein the control unit is configured for controlling the projector such that the area with the lower density is projected to an eye area of the human face.

Embodiment 5. The detector according to any one of the preceding embodiments, wherein the pulse parameter comprises at least one parameter selected from the group consisting of: pulse width, pulse shape, beginning of pulse, end of pulse, pulse period, repetition rate, energy per pulse, radiant flux, radiant exposure, radiant intensity.

Embodiment 6. The detector according to any one of the preceding embodiments, wherein the control unit is configured for controlling exposure times of the light emitters such that the light emitters emit their light beams with high intensity of emission and long break times, wherein the exposure times have microsecond timescales.

Embodiment 7. The detector according to any one of the preceding embodiments, wherein the control unit is configured for synchronizing the imaging of the camera and the emission of the pulsed light emitters.

Embodiment 8. The detector according to any one of the preceding embodiments, wherein the projector is configured for generating the illumination pattern comprising at least one pattern selected from the group consisting of: at least one quasi random pattern; at least one Sobol pattern; at least one quasiperiodic pattern; at least one point pattern; at least one line pattern; at least one stripe pattern; at least one checkerboard pattern; at least one triangular pattern; at least one hexagonal pattern; at least one rectangular pattern; at least one pattern comprising further convex tilings.

Embodiment 9. The detector according to any one of the preceding embodiments, wherein the evaluation device is configured for determining the position of the object by one or more of a beam profile analysis technique, at least one triangulation method.

Embodiment 10. The detector according to any one of the preceding embodiments, wherein the evaluation device is configured for determining a longitudinal coordinate for each of the reflection features by using a beam profile analysis technique comprising analysis of a beam profile of the reflection feature, wherein the analysis of the beam profile comprises determining at least one first area and at least one second area of the beam profile, wherein the evaluation device is configured for deriving a combined signal Q by one or more of dividing the first area and the second area, dividing multiples of the first area and the second area, dividing linear combinations of the first area and the second area, wherein the evaluation device is configured for using at least one predetermined relationship between the combined signal Q and the longitudinal coordinate for determining the longitudinal coordinate.

Embodiment 11. The detector according to any one of the preceding embodiments, wherein the evaluation device is configured for selecting at least one reflection feature of the reflection image and for assigning said reflection feature to the corresponding emitter, wherein the evaluation device is configured for determining the at least one longitudinal coordinate by using at least one triangulation method.

Embodiment 12. The detector according to any one of the preceding embodiments, wherein each of the emitter is and/or comprises at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser; at least one non-laser light source such as at least one LED or at least one light bulb.

Embodiment 13. The detector according to any one of the preceding embodiments, wherein the camera comprises at least one pixelated camera chip, wherein the camera comprises at least one CCD chip and/or at least one CMOS chip.

Embodiment 14. The detector according to any one of the preceding embodiments, wherein the camera is or comprises at least one near infrared camera.

Embodiment 15. The detector according to any one of the preceding embodiments, wherein the detector comprises at least one flood light source configured for illuminating a scene comprising the object, wherein the illumination from the flood light source has a predefined and/or predetermined light direction, wherein the camera is configured for imaging at least one pixelated flood image of the scene.

Embodiment 16. A mobile device configured for determining a position of at least one object, wherein the mobile device comprises at least one detector according to any one of the preceding embodiments, wherein the mobile device is one or more of a mobile communication device, a tablet computer, a portable computer.

Embodiment 17. A method for determining a position of at least one object by using at least one detector according to any one of the preceding embodiments referring to a detector, the method comprising the following steps:
illuminating at least one object with the illumination pattern using the projector;
controlling emission of the light emitters of the projector by using the control unit;
imaging at least one reflection image comprising a plurality of reflection features generated by the object in response to illumination by the illumination features by using the camera;
determining the position of the object by evaluating the reflection image by using the evaluation device.

Embodiment 18. A use of the detector according to any one of the preceding embodiments referring to a detector, for a purpose of use, selected from the group consisting of: a position measurement in traffic technology; an entertainment application; a security application; a surveillance application; a safety application; a human-machine interface application; a logistics application; a tracking application; an outdoor application; a mobile application; a communication application; a photography application; a machine vision application; a robotics application; a quality control application; a manufacturing application; an automotive application.

### BRIEF DESCRIPTION OF THE FIGURES

Further optional details and features of the invention are evident from the description of preferred exemplary embodiments which follows in conjunction with the dependent claims. In this context, the particular features may be implemented in an isolated fashion or in combination with other features. The invention is not restricted to the exemplary embodiments. The exemplary embodiments are shown schematically in the figures. Identical reference numerals in the individual figures refer to identical elements or elements with identical function, or elements which correspond to one another with regard to their functions.

Specifically, in the figures:

FIG. 1 shows an embodiment of a detector according to the present invention;

FIG. 2 shows an embodiment of a mobile device according to the present invention; and

FIG. 3 shows a flowchart of an embodiment of a method for determining a position of at least one object according to the present invention.

### DETAILED DESCRIPTION OF THE EMBODIMENTS

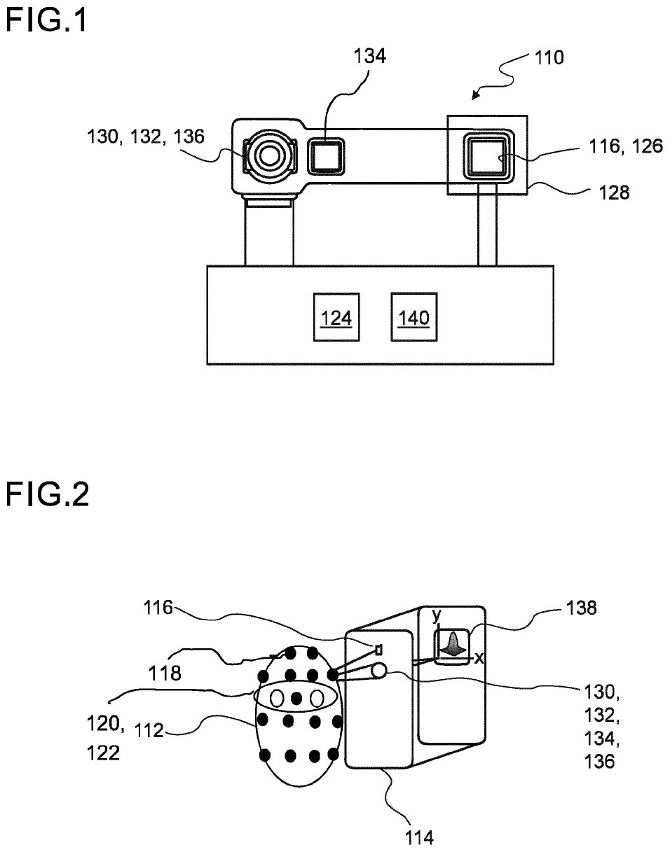

FIG. 1 shows in a highly schematic fashion an embodiment of a detector 110 for determining a position of at least one object 112 according to the present invention. For example, the object 112 may be a human, in particular a face. In FIG. 2 an exemplary object 112 is shown. As further shown in FIG. 2, the detector 110 may be one of attached to or integrated into a mobile device 114 such as a mobile phone or smartphone. The detector 110 may be integrated in a mobile device 114, e.g. within a housing of the mobile device 114. The mobile device 114 is one or more of a mobile communication device such as a cell phone or smartphone, a tablet computer, a portable computer.

The detector 110 comprises at least one projector 116 for illuminating the object 112 with at least one illumination pattern 118, e.g. as shown in FIG. 2. The illumination pattern 118 comprises a plurality of illumination features adapted to illuminate at least one part of the object 112. The illumination pattern 118 may comprise at least one pattern selected from the group consisting of: at least one quasi random pattern; at least one Sobol pattern; at least one quasiperiodic pattern; at least one point pattern, in particular a pseudo-random point pattern or a random point pattern; at least one line pattern; at least one stripe pattern; at least one checkerboard pattern; at least one triangular pattern; at least one rectangular pattern; at least one hexagonal pattern or a pattern comprising further convex tilings. The illumination pattern 118 may exhibit the at least one illumination feature selected from the group consisting of: at least one point; at least one line; at least two lines such as parallel or crossing lines; at least one point and one line; at least one arrangement of periodic or non-periodic feature; at least one arbitrary shaped featured. For example, the illumination pattern 118 comprises at least one pattern comprising at least one pre-known feature. For example, the illumination pattern comprises at least one line pattern comprising at least one line. For example, the illumination pattern 118 comprises at least one line pattern comprising at least two lines such as parallel or crossing lines. For example, the projector 116 may be configured for generate and/or to project a cloud of points or nonpoint-like features. For example, the projector 116 may be configured for generate a cloud of points or non-point-like features such that the illumination pattern 118 may comprise a plurality of point features or non-point-like features.

The illumination pattern 118 may comprise at least two areas having different densities of the illumination features. One of the areas 120 may have a lower density of the illumination features than the other one. The illumination pattern 118 may comprise at least two sub-patterns, wherein one sub-pattern is arranged in the area 120 with the lower density and another sub-pattern is arranged in the area with the higher density. A distance between two features of the respective illumination pattern 118 may depend on a circle of confusion in a reflection image determined by at least one detector. The area 120 with the lower density of the illumination features may have a larger distance between two illumination features than the area with the higher density. The area of the illumination pattern 118 having the higher density may comprise as many features per area as possible, e.g. a densely packed hexagonal pattern may be preferred. Each of the sub-patterns may comprise an arrangement of periodic or non periodic features. For example, each of the areas may comprise a periodic point pattern. Each of the areas may comprise at least one regular and/or constant and/or periodic pattern.

As shown in FIG. 2, the object 112 may be a human face. The human face may be subdivided into an eye area 122 comprising the human's eyes and other parts of the face, e.g. skin areas. The eye area 122, as the skilled person knows, requires specific protection from optical radiation. The detector 110 comprises at least one control unit 124. The control unit 124 may be configured for controlling the projector 116 such that the area 120 with the lower density of the illumination features is projected to a predefined area of the object 112. Specifically, the control unit 124 is configured for controlling the projector 116 such that the area 120 with the lower density is projected to the eye area 122 of the human face. Projecting a lower density sub-pattern to the eye area 122 may allow reducing the amount of optical radiation for the eyes and, thus, eye protection. The higher density sub-pattern may allow high resolution distance measurements in the other parts of the face.

The projector 116 comprises at least one array of pulsed light emitters 126. Each of the pulsed light emitters is configured for emitting at least one light beam. Each of the emitters may be and/or may comprise at least one element selected from the group consisting of at least one laser source such as at least one semi-conductor laser, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser (VCSEL); at least one non-laser light source such as at least one LED or at least one light bulb.

The array of emitters 126 may be a two-dimensional or one dimensional array. The array 126 may comprise a plurality of emitters arranged in a matrix. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point.

The array of emitters 126 may comprise at least two different array areas. The areas may be arbitrary shaped subsections and/or parts of the array 126. The emitters may be divided into subsections and/or parts of the array 126. The respective array area may comprise a plurality of emitters of the array 126. For example, the array 126 may be divided into two areas having different densities of the light emitters. One of the areas may have a lower density of the light emitters than the other one. The lower and higher density areas of emitters may correspond to the lower and higher density areas of the illumination pattern 118.

For example, the emitters may be an array of VCSELs. Examples for VCSELs can be found e.g. in en.wikipedia.org/wikiNertical-cavity_surface-emitting_laser. VCSELs are generally known to the skilled person such as from WO 2017/222618 A. Each of the VCSELs is configured for generating at least one light beam. The VCSELs may be arranged on a common substrate or on different substrates. The array may comprise up to 2500 VCSELs. For example, the array may comprise 38×25 VCSELs, such as a high power array with 3.5 W. For example, the array may comprise 10×27 VCSELs with 2.5 W. For example, the array may comprise 96 VCSELs with 0.9 W. A size of the array, e.g. of 2500 elements, may be up to 2 mm×2 mm.

The light beam emitted by the respective emitter may have a wavelength of 300 to 1100 nm, preferably 500 to 1100 nm. For example, the light beam may have a wavelength of 940 nm. For example, light in the infrared spectral range may be used, such as in the range of 780 nm to 3.0 μm. Specifically, the light in the part of the near infrared region where silicon photodiodes are applicable specifically in the range of 700 nm to 1100 nm may be used. The emitters may be configured for generating the at least one illumination pattern in the infrared region, in particular in the near infrared region. Using light in the near infrared region may allows that light is not or only weakly detected by human eyes and is still detectable by silicon sensors, in particular standard silicon sensors. For example, the emitters may be an array of VCSELs. The VCSELs may be configured for emitting light beams at a wavelength range from 800 to 1000 nm. For example, the VCSELs may be configured for emitting light beams at 808 nm, 850 nm, 940 nm, or 980 nm. Preferably the VCSELs emit light at 940 nm, since terrestrial sun radiation has a local minimum in irradiance at this wavelength, e.g. as described in CIE 085-1989“Solar spectral Irradiance”.

The light emitters are pulsed light emitters. The illumination pattern 118 may be pulsed. Specifically, the complete illumination pattern 118 may be pulsed. The light emitters may be configured for emitting repetitive pulses, in particular a pulse train. The pulsed light emitters may emit the light beams at spaced points in time. Between the emission of the light beams the pulsed light emitters may not emit light.

The detector 110 comprises at least one control unit 124 configured for controlling emission of each of the pulsed light emitters. The control unit 124 is configured for controlling emission of each of the pulsed light emitters. The controlling of the emission comprises controlling at least one pulse parameter, in particular a plurality of pulse parameters. The pulse parameter may comprise at least one parameter selected from the group consisting of: pulse width, pulse shape, beginning of pulse, end of pulse, pulse period, repetition rate, energy per pulse, radiant flux, radiant exposure, radiant intensity. The respective pulse parameter may be controlled such that at least one pre-defined limit for the respective pule parameter for laser class 1 is fulfilled, e.g. as defined in DIN EN 60825-1.

The control unit 124 may be configured for controlling exposure times of the light emitters such that the light emitters emit their light beams with high intensity of emission and long break times. The exposure times and break times may be defined by the pulse width and the repetition rate. The exposure times may have microsecond timescales. For example, the exposure times are from 1 ms to 2 ms. Using such short exposure times may prevent the eye from focusing such that further eye protection can be reached. The exposure times may be set such that limits for exposure times for laser class 1 are fulfilled, e.g. as defined in DIN EN 60825-1. The proposed short exposure times may allow running the light emitters with high power and at the same time fulfilling the requirements for laser class 1, e.g. as defined in DIN EN 60825-1. The possibility of running the light emitters with high power may allow ensuring sufficient contrast for the reflection image for determining the position of the object 112, therefrom. The control unit 124 may be configured for controlling setting of exposure times may comprise

For example, each of the light emitters may comprises at least one shutter 128 and/or the light emitters may comprise a common shutter 128. The control unit 124 may be configured for controlling exposure times by controlling the shutter. The shutter may be configured for temporally blocking light from the light emitters and temporally allowing light from the light emitters to pass. The blocking may comprise complete blocking of light and/or at least partially blocking light such that light from the respective emitters. For example, the blocking may comprise blocking of more than 90% of incoming intensity, preferably of more than 95% of incoming intensity. The control unit 124 may be configured for controlling the shutter e.g. by rotating and/or mechanically opening and closing apertures. Additionally or alternatively, the control unit 124 may be configured for driving the array of emitters such that the array is non-continuously emitting light. The control unit may 124 be configured for, in particular periodically, turning off and on the light emitters of the array. The controlling may be performed by hardware such as by at least one electrical circuit and/or by software.

The detector comprises at least one camera 130. The camera 130 comprises at least one sensor element 132 having a matrix of optical sensors 136. The optical sensors 136 each having a light-sensitive area. Each optical sensor 136 is designed to generate at least one sensor signal in response to an illumination of its respective light-sensitive area by a reflection light beam propagating from the object 112 to the camera 130. The camera 130 is configured for imaging at least one reflection image comprising a plurality of reflection features.

The control unit 124 may be configured for synchronizing the imaging of the camera 130 and the emission of the pulsed light emitters. Specifically, the emission of the pulsed light emitters, in particular the repetition rate, may be synchronized to an imaging frame rate of a camera 130 of the detector 110. For example, the emission of the light emitters may be synchronized to a 60 Hz—imaging frame rate of the camera 130. For example, the camera 130 may be active, i.e. in a mode for capturing images and/or detecting light, during the emission. For example, the synchronization of the camera 130 and the light emitters may be realized by the camera 130 emitting a VSYNC signal, also denoted as camera VSYNC, to the control unit 124 and a strobe signal to the projector 116, wherein the control unit 124 issues in response to the camera VSYNC a trigger signal to the projector 116 for activating the light emitters. In case the trigger signal and the strobe signal are received by the projector 116, the light emitter may start with the emission(s). However, other embodiments for synchronizing camera 130 and projector 116 are possible.

The projector 116 may comprise at least one transfer device, not shown here, configured for generating the illumination features from the light beams impinging on the transfer device. The transfer device specifically may comprise one or more of: at least one lens, for example at least one lens selected from the group consisting of at least one focus-tunable lens, at least one aspheric lens, at least one spheric lens, at least one Fresnel lens; at least one diffractive optical element; at least one concave mirror; at least one beam deflection element, preferably at least one mirror; at least one beam splitting element, preferably at least one of a beam splitting cube or a beam splitting mirror; at least one multi-lens system; at least one holographic optical element; at least one meta optical element. Specifically, the transfer device comprises at least one refractive optical lens stack. Thus, the transfer device may comprise a multi-lens system having refractive properties.

In addition to the projector 116, the detector 110 may comprise further illumination sources. For example, the detector 110 comprises at least one flood light source 134 configured for illuminating a scene comprising the object 112. The illumination from the flood light source 134 may have a predefined and/or predetermined light direction. The camera 130 may be configured for imaging at least one pixelated flood image of the scene. The flood light source may be configured for scene illumination. The scene may comprise the at least one object and a surrounding environment. The flood light source 134 may be adapted to directly or indirectly illuminating the object 112, wherein the illumination is reflected or scattered by surfaces of the object and, thereby, is at least partially directed towards the sensor element 132. The flood light source 134 may be adapted to illuminate the object 112, for example, by directing a light beam towards the object 112, which reflects the light beam. The flood light source 134 may comprise at least one light-emitting-diode (LED). However, other embodiments are feasible. For example, the flood light source 134 may comprise at least one VCSEL and at least one diffusor as light source. The flood light source 134 may comprise a single light source or a plurality of light sources. The flood light source 134 may emit light in the same wavelength as the projector or may emit light in at least one further wavelength range.

The projector 116 and/or the flood light source 134 may constitute a coordinate system, wherein a longitudinal coordinate is a coordinate along the optical axis. The coordinate system may be a polar coordinate system in which the optical axis forms a z-axis and in which a distance from the z-axis and a polar angle may be used as additional coordinates. A direction parallel or antiparallel to the z-axis may be considered a longitudinal direction, and a coordinate along the z-axis may be considered a longitudinal coordinate z. Any direction perpendicular to the z-axis may be considered a transversal direction, and the polar coordinate and/or the polar angle may be considered a transversal coordinate.

The camera 130 may comprise at least one camera chip, such as at least one CCD chip and/or at least one CMOS chip configured for recording images. For example, the camera 130 is or comprises at least one near infrared camera.

The optical sensors 136 of the camera 130 specifically may be or may comprise at least one photodetector, preferably inorganic photodetectors, more preferably inorganic semiconductor photodetectors, most preferably silicon photodetectors. Specifically, the optical sensor 136 may be sensitive in the infrared spectral range. All pixels of the matrix or at least a group of the optical sensors of the matrix specifically may be identical. Groups of identical pixels of the matrix specifically may be provided for different spectral ranges, or all pixels may be identical in terms of spectral sensitivity. Further, the pixels may be identical in size and/or with regard to their electronic or optoelectronic properties. Specifically, the optical sensor 136 may be or may comprise at least one inorganic photodiode which are sensitive in the infrared spectral range, preferably in the range of 700 nm to 3.0 micrometers. Specifically, the optical sensor 136 may be sensitive in the part of the near infrared region where silicon photodiodes are applicable specifically in the range of 700 nm to 1100 nm. Infrared optical sensors which may be used for optical sensors may be commercially available infrared optical sensors, such as infrared optical sensors commercially available under the brand name Hertzstueck™ from trinamiX™ GmbH, D-67056 Ludwigshafen am Rhein, Germany. Thus, as an example, the optical sensor 136 may comprise at least one optical sensor of an intrinsic photovoltaic type, more preferably at least one semi-conductor photodiode selected from the group consisting of: a Ge photodiode, an InGaAs photodiode, an extended InGaAs photodiode, an InAs photodiode, an InSb photodiode, a HgCdTe photodiode. Additionally or alternatively, the optical sensor 136 may comprise at least one optical sensor of an extrinsic photovoltaic type, more preferably at least one semiconductor photodiode selected from the group consisting of: a Ge:Au photodiode, a Ge:Hg photodiode, a Ge:Cu photodiode, a Ge:Zn photodiode, a Si:Ga photodiode, a Si:As photodiode. Additionally or alternatively, the optical sensor 136 may comprise at least one photoconductive sensor such as a PbS or PbSe sensor, a bolometer, preferably a bolometer selected from the group consisting of a VO bolometer and an amorphous Si bolometer.

The optical sensor 136 may be sensitive in one or more of the ultraviolet, the visible or the infrared spectral range. Specifically, the optical sensor may be sensitive in the visible spectral range from 500 nm to 780 nm, most preferably at 650 nm to 750 nm or at 690 nm to 700 nm. Specifically, the optical sensor 136 may be sensitive in the near infrared region. Specifically, the optical sensor 136 may be sensitive in the part of the near infrared region where silicon photodiodes are applicable specifically in the range of 700 nm to 1000 nm. The optical sensor 136, specifically, may be sensitive in the infrared spectral range, specifically in the range of 780 nm to 3.0 micrometers. For example, the optical sensor each, independently, may be or may comprise at least one element selected from the group consisting of a photodiode, a photocell, a photoconductor, a phototransistor or any combination thereof. For example, the optical sensor 136 may be or may comprise at least one element selected from the group consisting of a CCD sensor element, a CMOS sensor element, a photodiode, a photocell, a photoconductor, a phototransistor or any combination thereof. Any other type of photosensitive element may be used. The photosensitive element generally may fully or partially be made of inorganic materials and/or may fully or partially be made of organic materials. Most commonly, one or more photodiodes may be used, such as commercially available photodiodes, e.g. inorganic semiconductor photodiodes.

The optical sensor 136 may comprise the sensor element 132 comprising a matrix of pixels. Thus, as an example, the optical sensor 136 may be part of or constitute a pixelated optical device. For example, the optical sensor 136 may be and/or may comprise at least one CCD and/or CMOS device. As an example, the optical sensor 136 may be part of or constitute at least one CCD and/or CMOS device having a matrix of pixels, each pixel forming a light-sensitive area. The sensor element 132 may be formed as a unitary, single device or as a combination of several devices. The matrix specifically may be or may comprise a rectangular matrix having one or more rows and one or more columns. The rows and columns specifically may be arranged in a rectangular fashion. However, other arrangements are feasible, such as nonrectangular arrangements. As an example, circular arrangements are also feasible, wherein the elements are arranged in concentric circles or ellipses about a center point. For example, the matrix may be a single row of pixels. Other arrangements are feasible.

The pixels of the matrix specifically may be equal in one or more of size, sensitivity and other optical, electrical and mechanical properties. The light-sensitive areas of all optical sensors 136 of the matrix specifically may be located in a common plane, the common plane preferably facing the scene, such that a light beam propagating from the object 112 to the detector 110 may generate a light spot on the common plane. The light-sensitive area may specifically be located on a surface of the respective optical sensor 136. Other embodiments, however, are feasible. The camera 130 may comprise for example, at least one CCD and/or CMOS device. As an example, the camera 130 may be part of or constitute a pixelated optical device. As an example, the optical sensor 136 may be part of or constitute at least one CCD and/or CMOS device having a matrix of pixels, each pixel forming a light-sensitive area.

The reflection image may be an image determined by the optical sensors 136 comprising a plurality of reflection features. The reflection feature may be a feature in an image plane generated by the object 112 in response to illumination with at least one illumination feature. The reflection image may comprise the at least one reflection pattern comprising the reflection features.

Each of the reflection features comprises at least one beam profile 138. The beam profile 138 may be a spatial distribution, in particular in at least one plane perpendicular to the propagation of the light beam, of an intensity of the light beam. The beam profile 138 may be a transverse intensity profile of the light beam. The beam profile 138 may be a cross section of the light beam. The beam profile 138 may be selected from the group consisting of a trapezoid beam profile; a triangle beam profile; a conical beam profile and a linear combination of Gaussian beam profiles. Other embodiments are feasible, however.

The detector 110 comprises at least one evaluation device 140. The evaluation device 140 is configured for determining the position of the object 112 by evaluating the reflection image. The evaluation device 140 may be configured for determining the x- and y-coordinates of the reflection features from their xy-coordinates in the pixelated reflection image. The evaluation device 140 may be configured for determining the position of the object 112, in particular its longitudinal coordinate, by one or more of a beam profile analysis technique, at least one triangulation method.

For example, the evaluation device is configured for determining a longitudinal coordinate, also denoted as z_{DPR}, for each of the reflection features by using a beam profile analysis technique comprising analysis of a beam profile of the reflection feature. The evaluation device 140 may be configured for determining the longitudinal coordinate for each of the reflection features by using a depth-from-photon-ratio technique, also denoted as beam profile analysis. With respect to depth-from-photon-ratio (DPR) technique reference is made to WO 2018/091649 A1, WO 2018/091638 A1, WO 2018/091640 A1 and C. Lennartz, F. Schick, S. Metz, “Whitepaper—Beam Profile Analysis for 3D imaging and material detection” Apr. 28, 2021, Ludwigshafen, Germany, the full content of which is included by reference.

The evaluation device 140 may be configured for selecting reflection features of the respective first and second reflection images. The selecting may comprise to one or more of identifying, determining and choosing at least one reflection feature of the reflection image. The evaluation device 140 may be configured for performing at least one image analysis and/or image processing in order to identify the reflection features. The image analysis and/or image processing may use at least one feature detection algorithm. The image analysis and/or image processing may comprise one or more of the following: a filtering; a selection of at least one region of interest; a formation of a difference image between an image created by the sensor signals and at least one offset; an inversion of sensor signals by inverting an image created by the sensor signals; a formation of a difference image between an image created by the sensor signals at different times; a background correction; a decomposition into color channels; a decomposition into hue; saturation; and brightness channels; a frequency decomposition; a singular value decomposition; applying a Canny edge detector; applying a Laplacian of Gaussian filter; applying a Difference of Gaussian filter; applying a Sobel operator; applying a Laplace operator; applying a Scharr operator; applying a Prewitt operator; applying a Roberts operator; applying a Kirsch operator; applying a high-pass filter; applying a low-pass filter; applying a Fourier transformation; applying a Radon-transformation; applying a Hough-transformation; applying a wavelet-transformation; a thresholding; creating a binary image. The region of interest may be determined manually by a user or may be determined automatically, such as by recognizing an object within an image generated by the optical sensors 136.

The evaluation device 140 is configured for determining at least one longitudinal coordinate, also denoted as z_{DPR}, for each of the reflection features by analysis of their beam profiles 138. The analysis of the beam profile 138 may comprise evaluating of the beam profile and may comprise at least one mathematical operation and/or at least one comparison and/or at least symmetrizing and/or at least one filtering and/or at least one normalizing. For example, the analysis of the beam profile may comprise at least one of a histogram analysis step, a calculation of a difference measure, application of a neural network, application of a machine learning algorithm. The evaluation device 140 may be configured for symmetrizing and/or for normalizing and/or for filtering the beam profile, in particular to remove noise or asymmetries from recording under larger angles, recording edges or the like. The evaluation device 140 may filter the beam profile by removing high spatial frequencies such as by spatial frequency analysis and/or median filtering or the like. Summarization may be performed by center of intensity of the light spot and averaging all intensities at the same distance to the center. The evaluation device 140 may be configured for normalizing the beam profile to a maximum intensity, in particular to account for intensity differences due to the recorded distance. The evaluation device 140 may be configured for removing influences from background light from the beam profile, for example, by an imaging without illumination.

The analysis of the beam profile 140 of one of the reflection features may comprise determining at least one first area and at least one second area of the beam profile 138. The first area of the beam profile may be an area A1 and the second area of the beam profile may be an area A2. The evaluation device 140 may be configured for integrating the first area and the second area. The evaluation device 140 may be configured to derive a combined signal Q, also denoted as quotient Q, by one or more of dividing the integrated first area and the integrated second area, dividing multiples of the integrated first area and the integrated second area, dividing linear combinations of the integrated first area and the integrated second area. The evaluation device 140 may be configured for using the at least one predetermined relationship between the combined signal and the longitudinal coordinate for determining the longitudinal coordinate. The predetermined relationship may be one or more of an empiric relationship, a semi-empiric relationship and an analytically derived relationship. The evaluation device 140 may comprise at least one data storage device for storing the predetermined relationship, such as a lookup list or a lookup table.

The evaluation device 140 may be configured for assigning said reflection feature to the corresponding emitter. The assigning of a reflection feature to the corresponding emitter of the array 126 may comprise determining, in particular unambiguously, the one emitter of the array 126 having emitted the illumination feature having caused the selected reflection feature. In known 3D sensing devices, such as devices using triangulation or structured light techniques, solving this correspondence problem is complex and time consuming. The evaluation device 140 may be configured for unambiguously matching of reflection features with corresponding emitters by using the longitudinal coordinate z_{DPR}. The longitudinal coordinate determined with the depth-from-photon-ratio technique can be used for solving the correspondence problem. In that way, distance information per reflection feature can be used to find the correspondence of the known array of emitters. The matching may comprise identifying and/or determining and/or evaluating the corresponding emitter and the reflection feature.

The illumination feature, and thus, the emitter, corresponding to the reflection feature may be determined using epipolar geometry. For description of epipolar geometry reference is made, for example, to chapter 2 in X. Jiang, H. Bunke: “Dreidimensionales Computersehen” Springer, Berlin Heidelberg, 1997. Epipolar geometry may assume that an illumination image, i.e. an image of the non-distorted illumination pattern, and the reflection image may be images determined at different spatial positions and/or spatial orientations having a fixed distance. The distance may be a relative distance, also denoted as baseline. The illumination image may be also denoted as reference image. The evaluation device 140 may be adapted to determine an epipolar line in the reference image. The relative position of the reference image and reflection image may be known. For example, the relative position of the reference image and the reflection image may be stored within at least one storage unit of the evaluation device 140. The evaluation device 140 may be adapted to determine a straight line extending from a selected reflection feature of the reflection image to a real world feature from which it originates. Thus, the straight line may comprise possible object features corresponding to the selected reflection feature. The straight line and the baseline span an epipolar plane. As the reference image is determined at a different relative constellation from the reflection image, the corresponding possible object features may be imaged on a straight line, called epipolar line, in the reference image. The epipolar line may be the intersection of the epipolar plane and the reference image. Thus, a feature of the reference image corresponding to the selected feature of the reflection image lies on the epipolar line.

Depending on the distance to the object 112 having reflected the illumination feature, the reflection feature corresponding to the illumination feature may be displaced within the reflection image. The reference image may comprise at least one displacement region in which the illumination feature corresponding to the selected reflection feature would be imaged. The displacement region may comprise only one illumination feature. The displacement region may also comprise more than one illumination feature. The displacement region may comprise an epipolar line or a section of an epipolar line. The displacement region may comprise more than one epipolar line or more sections of more than one epipolar line. The displacement region may extend along the epipolar line, orthogonal to an epipolar line, or both. The evaluation device 140 may be adapted to determine the illumination feature along the epipolar line. The evaluation device 140 may be adapted to determine the longitudinal coordinate z for the reflection feature and an error interval ±ε from the combined signal Q to determine a displacement region along an epipolar line corresponding to z±ε or orthogonal to an epipolar line. The measurement uncertainty of the distance measurement using the combined signal Q may result in a displacement region in the second image which is non-circular since the measurement uncertainty may be different for different directions. Specifically, the measurement uncertainty along the epipolar line or epipolar lines may be greater than the measurement uncertainty in an orthogonal direction with respect to the epipolar line or lines. The displacement region may comprise an extend in an orthogonal direction with respect to the epipolar line or epipolar lines. The evaluation device 140 may be adapted to match the selected reflection feature with at least one illumination feature within the displacement region. The evaluation device 140 may be adapted to match the selected feature of the reflection image with the illumination feature within the displacement region by using at least one evaluation algorithm considering the determined longitudinal coordinate z_{DPR}. The evaluation algorithm may be a linear scaling algorithm. The evaluation device 140 may be adapted to determine the epipolar line closest to and/or within the displacement region. The evaluation device 140 may be adapted to determine the epipolar line closest to the image position of the reflection feature. The extent of the displacement region along the epipolar line may be larger than the extent of the displacement region orthogonal to the epipolar line. The evaluation device 140 may be adapted to determine an epipolar line before determining a corresponding illumination feature. The evaluation device 140 may determine a displacement region around the image position of each reflection feature. The evaluation device 140 may be adapted to assign an epipolar line to each displacement region of each image position of the reflection features, such as by assigning the epipolar line closest to a displacement region and/or within a displacement region and/or closest to a displacement region along a direction orthogonal to the epipolar line. The evaluation device 140 may be adapted to determine the illumination feature corresponding to the reflection feature by determining the illumination feature closest to the assigned displacement region and/or within the assigned displacement region and/or closest to the assigned displacement region along the assigned epipolar line and/or within the assigned displacement region along the assigned epipolar line.

The evaluation device 140 may be configured for determining at least one longitudinal coordinate z_{triang} by using at least one triangulation method. The evaluation device 140 may be adapted to determine a displacement of the illumination feature and the reflection feature. The evaluation device 140 may be adapted to determine the displacement of the matched illumination feature and the selected reflection feature. The evaluation device 140, e.g. at least one data processing device of the evaluation device, may be configured to determine the displacement of the illumination feature and the reflection feature, in particular by comparing the respective image position of the illumination image and the reflection image. The displacement may be the difference between an image position in the illumination image to an image position in the reflection image. The evaluation device 140 may be adapted to determine the second longitudinal coordinate of the matched feature using a predetermined relationship between the second longitudinal coordinate and the displacement. The evaluation device 140 may be adapted to determine the pre-determined relationship by using triangulation methods.

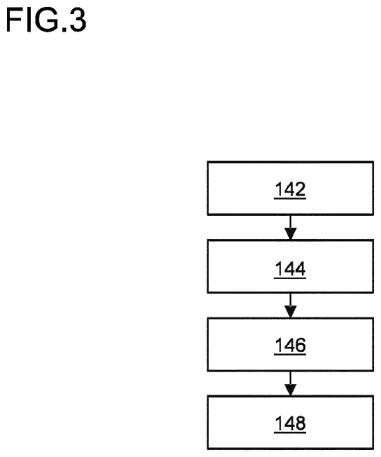

FIG. 3 shows a flowchart of an embodiment of a method for determining a position of at least one object 112 according to the present invention. In the method the at least one detector 110 according to the present invention is used. Thus, reference is made to FIGS. 1 and 2. The method steps may be performed in the given order or may be performed in a different order. Further, one or more additional method steps may be present which are not listed. Further, one, more than one or even all of the method steps may be performed repeatedly.

The method comprises the following steps:
(denoted with reference number 142) illuminating at least one object 112 with the illumination pattern 118 using the projector 116;
(denoted with reference number 144) controlling emission of the light emitters of the projector 116 by using the control unit 124;
   (denoted with reference number 146) imaging at least one reflection image comprising a plurality of reflection features generated by the object 112 in response to illumination by the illumination features by using the camera 130;
(denoted with reference number 148) determining the position of the object 112 by evaluating the reflection image by using the evaluation device 140.

### LIST OF REFERENCE NUMBERS

110 detector
112 object
114 mobile device
116 projector
118 illumination pattern
120 area
122 eye area
124 control unit
126 array of pulsed light emitters
128 shutter
130 camera
132 sensor element
134 flood light source
136 optical sensor
138 beam profile
140 evaluation device
142 illuminating
144 controlling
146 imaging
148 determining the position

1. A detector for determining a position of at least one object, the detector comprising:
at least one projector for illuminating the object with at least one illumination pattern, wherein the illumination pattern comprises a plurality of illumination features, wherein the projector comprises at least one array of pulsed light emitters, wherein each of the pulsed light emitters is configured for emitting at least one light beam;
at least one camera, wherein the camera comprises at least one sensor element having a matrix of optical sensors, the optical sensors each having a light-sensitive area, wherein each optical sensor is designed to generate at least one sensor signal in response to an illumination of its respective light-sensitive area by a reflection light beam propagating from the object to the camera, wherein the camera is configured for imaging at least one reflection image comprising a plurality of reflection features;
at least one control unit configured for controlling emission of each of the pulsed light emitters, wherein the controlling of the emission comprises controlling at least one pulse parameter; and
at least one evaluation device configured for determining the position of the object by evaluating the reflection image.

2. The detector according to claim 1, wherein the illumination pattern comprises at least two areas having different densities of the illumination features, wherein one of the areas has a lower density of the illumination features than the other one.

3. The detector according to claim 2, wherein the control unit is configured for controlling the projector such that the area with the lower density of the illumination features is projected to a predefined area of the object.

4. The detector according to claim 3, wherein the object is a human face, wherein the control unit is configured for controlling the projector such that the area with the lower density is projected to an eye area of the human face.

5. The detector according to claim 1, wherein the pulse parameter comprises at least one parameter selected from the group consisting of: pulse width, pulse shape, beginning of pulse, end of pulse, pulse period, repetition rate, energy per pulse, radiant flux, radiant exposure, and radiant intensity.

6. The detector according to claim 1, wherein the control unit is configured for controlling exposure times of the light emitters such that the light emitters emit their light beams with high intensity of emission and long break times, wherein the exposure times have microsecond timescales.

7. The detector according to claim 1, wherein the control unit is configured for synchronizing the imaging of the camera and the emission of the pulsed light emitters.

8. The detector according to claim 1, wherein the evaluation device is configured for determining the position of the object by one or more of a beam profile analysis technique, at least one triangulation method.

9. The detector according to claim 1, wherein the evaluation device is configured for determining a longitudinal coordinate for each of the reflection features by using a beam profile analysis technique comprising analysis of a beam profile of the reflection feature, wherein the analysis of the beam profile comprises determining at least one first area and at least one second area of the beam profile, wherein the evaluation device is configured for deriving a combined signal Q by one or more of dividing the first area and the second area, dividing multiples of the first area and the second area, dividing linear combinations of the first area and the second area, wherein the evaluation device is configured for using at least one predetermined relationship between the combined signal Q and the longitudinal coordinate for determining the longitudinal coordinate.

10. The detector according to claim 1, wherein each of the emitter is and/or comprises at least one element selected from the group consisting of at least one laser source, at least one double heterostructure laser, at least one external cavity laser, at least one separate confinement heterostructure laser, at least one quantum cascade laser, at least one distributed Bragg reflector laser, at least one polariton laser, at least one hybrid silicon laser, at least one extended cavity diode laser, at least one quantum dot laser, at least one volume Bragg grating laser, at least one Indium Arsenide laser, at least one Gallium Arsenide laser, at least one transistor laser, at least one diode pumped laser, at least one distributed feedback lasers, at least one quantum well laser, at least one interband cascade laser, at least one semiconductor ring laser, at least one vertical cavity surface-emitting laser; and at least one non-laser light source.

11. The detector according to claim 1, wherein the camera comprises at least one pixelated camera chip, wherein the camera comprises at least one CCD chip and/or at least one CMOS chip.

12. The detector according to claim 1, wherein the camera is or comprises at least one near infrared camera.

13. A mobile device configured for determining a position of at least one object, wherein the mobile device comprises at least one detector according to claim 1, wherein the mobile device is one or more of a mobile communication device, a tablet computer, or a portable computer.

14. A method for determining a position of at least one object by using at least one detector according to claim 1, the method comprising the following steps:
illuminating at least one object with the illumination pattern using the projector;
controlling emission of the light emitters of the projector by using the control unit;
imaging at least one reflection image comprising a plurality of reflection features generated by the object in response to illumination by the illumination features by using the camera; and
determining the position of the object by evaluating the reflection image by using the evaluation device.

15. A method of using the detector according to claim 1, the method comprising using the detector for a purpose, selected from the group consisting of a position measurement in traffic technology; an entertainment application; a security application; a surveillance application; a safety application; a human-machine interface application; a logistics application; a tracking application; an outdoor application; a mobile application; a communication application; a photography application; a machine vision application; a robotics application; a quality control application; a manufacturing application; and an automotive application.

16. The detector according to claim 10, wherein at least one laser source is at least one semi-conductor laser.

17. The detector according to claim 10, wherein at least one non-laser light source is at least one LED or at least one light bulb.
